(19) United States
(12) Patent Application Publication
(10) Pub. No.: US 2022/0008163 A1
(43) Pub. Date: Jan. 13, 2022

(54) DEVICES AND METHODS FOR SHAPING A TOOTH

(71) Applicant: DROBOTICS LTD., Rishon LeZion (IL)

(72) Inventors: Amit OZERY, Rishon LeZion (IL); Itshak COHEN, Ramat HaSharon (IL)

(21) Appl. No.: 17/293,607

(22) PCT Filed: Nov. 21, 2019
(86) PCT No.: PCT/IL2019/051275

§ 371 Date: May 13, 2021

Related U.S. Application Data
(60) Provisional application No. 62/770,853, filed on Nov. 23, 2018.

(51) Int. Cl. A61C 1/08; A61C 5/80; A61C 1/05; A61C 5/30; A61C 13/271; G05B 19/4155

(52) U.S. Cl. CPC A61C 1/082; A61C 5/80; A61C 1/05; G05B 2219/33099; A61C 13/26; G05B 19/4155; G05B 2219/45167; A61C 5/30

(57) ABSTRACT

Disclosed herein is a mountable dental device for shaping a tooth of a subject. The device includes: (i) an anchoring member configured to be removably affixed to a jaw of a subject by securing thereof to one or more teeth of the subject, and (ii) a computerized numerical control (CNC) machine fixedly mounted or mountable on the anchoring member. The CNC machine is configured to have installed thereon and maneuver a dental turbine. When the anchoring member is affixed to the jaw, the device is supported by the subject. The anchoring member is adjustable such as to allow the affixing thereof to jaws of different subjects. The CNC machine is configured to control operation of the dental turbine in at least one dental tooth-shaping procedure on at least one tooth of the subject.

### TECHNICAL FIELD

The present disclosure relates generally to the field of dental tooth-shaping.

### BACKGROUND

Many dental procedures involve shaping of one or more teeth, for example, in preparation for the installation of a dental crown or bridge. Typically, the shaping is performed manually and thus may be not only time-consuming but also inaccurate. Inaccuracies in the shaping of a tooth may lead, for example, to inflammation of the gums, cavities, failure of the tooth, and/or failure of the dental crown. There is thus a need for improved dental tooth-shaping devices and methods.

### SUMMARY

Aspects of the disclosure, according to some embodiments thereof, relate to dental devices and methods for shaping teeth. More specifically, but not exclusively, aspects of the disclosure, according to some embodiments thereof, relate to dental devices and methods for grinding a tooth in preparation for the installation of a dental crown.

The present disclosure, according to some embodiments thereof, provides a dental device for shaping a tooth, for example, in preparation for installing a dental crown on the tooth. According to some embodiments, the dental device includes a computerized numerical control (CNC) machine configured to autonomously maneuver and control the operation of a dental turbine (utilized in shaping the tooth). The dental device is configured to be affixed to a jaw of a subject by securing an anchoring member of the dental device to a plurality of teeth of the subject. When affixed, the dental device is supported by the jaw of the subject. This ensures that if the subject moves the jaw, the dental device moves along with the jaw, and, in particular, remains stationary with respect to a target tooth (which is to be shaped). Consequently, problems and complications arising from involuntary movements (e.g. reflex motion) of the subject, which may affect dental devices that receive external support (for example, dental devices that are at least partially supported by the ground or by the dentist's chair), are thereby eliminated or at least mitigated.

As a further advantage, according to some embodiments, the CNC machine (or a bulk thereof) may be detached from and reproducibly reattached to the anchoring member in the sense that, after the reattachment, the dental turbine assumes the same spatial relation with respect to the target tooth as prior to the detachment. Since when the CNC machine is detached, the subject may close their mouth, the above option allows for rest intervals during a dental tooth-shaping procedure, during which the subject may relax their jaw muscles.

The present disclosure, according to some embodiments, further provides a method for shaping a tooth utilizing the disclosed dental device. Following the affixing of the dental device to the jaw of the subject, the dentist may set orientation of the dental turbine, such that a drill bit is optimally directed (oriented) relative to a long axis of a target tooth or a plurality of long axes of a plurality of target teeth (e.g. when the tooth-shaping procedure is preparation of installation of a dental bridge). An imager may then be employed to obtain data indicative of a structure of the target tooth/teeth, as well as data indicative of a distance between the drill bit and the target tooth and the orientation of the drill bit relative to the target tooth/teeth. For example, a 3D scanner may be used to scan the target tooth/teeth together with the drill bit. By establishing the spatial relation between the target tooth/teeth and the drill bit, advantageously, highly accurate tooth-shaping instructions for the CNC machine may be generated.

Thus, according to an aspect of some embodiments, there is provided a mountable dental device for shaping a tooth of a subject. The dental device includes:
An anchoring member configured to be removably affixed to a jaw of a subject by securing thereof to one or more teeth of the subject.
A computerized numerical control (CNC) machine fixedly mounted or fixedly mountable on the anchoring member.

The CNC machine is configured to have installed thereon and maneuver a dental turbine. When the anchoring member is affixed to the jaw, the device is supported by the subject. The anchoring member is adjustable such as to allow the affixing thereof to jaws of different subjects. The CNC machine is configured to control operation of the dental turbine in at least one dental tooth-shaping procedure on at least one tooth of the subject.

According to some embodiments of the dental device, the at least one dental tooth-shaping procedure includes grinding of a tooth in preparation for installing a dental crown on the tooth.

According to some embodiments of the dental device, the at least one dental tooth-shaping procedure includes/further includes grinding at least two teeth in preparation for installing a dental bridge on the at least two teeth.

According to some embodiments of the dental device, the at least one dental tooth-shaping procedure may include/additionally include grinding of a tooth in preparation for installing a dental inlay, onlay, or overlay on the tooth.

According to some embodiments of the dental device, the at least one tooth includes a mandibular tooth and the device is configured to be affixed to a lower jaw of the subject, and/or the at least one tooth includes a maxillary tooth and the device is configured to be affixed to an upper jaw of the subject.

According to some embodiments of the dental device, the dental device further includes the dental turbine.

According to some embodiments of the dental device, the CNC machine includes turbine maneuvering infrastructure configured to allow controllably moving at least a distal portion of the dental turbine along each of three independent directions and/or arcs.

According to some embodiments of the dental device, the turbine maneuvering infrastructure is configured to allow moving the distal portion of the dental turbine at least about 15 mm along each of the three independent directions and/or arcs.

According to some embodiments of the dental device, the turbine maneuvering infrastructure is configured to allow controllably translating the distal portion of dental turbine along each of three orthogonal axes of a Cartesian coordinate system.

According to some embodiments of the dental device, the turbine maneuvering infrastructure includes three linear guiding assemblies configured to allow controllably translating the distal portion of the dental turbine along each of the three orthogonal axes, respectively.

According to some embodiments of the dental device, each of the linear guiding assemblies includes a linear guide and a carriage mounted on the linear guide and configured to be translated there along.

According to some embodiments of the dental device, each of the linear guiding assemblies further includes a lead screw and a nut mounted thereon and connected to the carriage of the (respective) linear guiding assembly.

According to some embodiments of the dental device, the linear guiding assemblies include a first linear guiding assembly, a second linear guiding assembly, and a third linear guiding assembly. The dental turbine is installable on the third linear guiding assembly and is configured to be translated thereby. The third linear guiding assembly is mounted on the second linear guiding assembly and is configured to be translated thereby. The second linear guiding assembly is mounted on the first linear guiding assembly and is configured to be translated thereby.

According to some embodiments of the dental device, the turbine maneuvering infrastructure includes three guiding assemblies. Each guiding assembly is configured to allow varying a respective coordinate from three coordinates of a coordinate system parameterizing a position of the distal portion of the dental turbine. The coordinate system may be a spherical coordinate system or a cylindrical coordinate system.

According to some embodiments of the dental device, the CNC machine includes three motors configured to controllably move the distal portion of the dental turbine along the three independent directions/arcs.

According to some embodiments of the dental device, each of the three motors includes a DC motor, a piezoelectric motor, a stepper motor, a brushless motor, and/or a hydraulic piston motor.

According to some embodiments of the dental device, wherein the turbine maneuvering infrastructure includes the three linear guiding assemblies, and wherein each of the linear guiding assemblies includes a respective one of the linear guides and a respective one of the carriages, each of the three motors is mechanically associated with the three linear guiding assemblies, respectively. Each motor is configured to induce the motion of the respective carriage on the respective linear guide.

According to some embodiments of the dental device, the motors and the dental turbine are functionally associated with a controller configured to control operation thereof.

According to some embodiments of the dental device, the dental devices further includes the controller and, optionally, a wireless communication unit configured to communicatively associate the controller with an external processing circuitry.

According to some embodiments of the dental device, the turbine maneuvering infrastructure is configured to be mechanically coupled to a mechanical actuation unit. The mechanical actuation unit is configured to cause the turbine maneuvering infrastructure to move at least the distal portion of the dental turbine.

According to some embodiments of the dental device, the turbine maneuvering infrastructure is configured to be mechanically coupled to the mechanical actuation unit via three mechanical actuation cables. Each of the mechanical actuation cables is configured to induce motion of at least the distal portion of the dental turbine along each of the three independent directions and/or arcs, respectively.

According to some embodiments of the dental device, each of the mechanical actuation cables is a torque transmitting flexible shaft, a pull-force transmitting flexible shaft, or a hydraulic flexible tube.

According to some embodiments of the dental device, wherein the turbine maneuvering infrastructure includes the three linear guiding assemblies, and wherein each of the linear guiding assemblies includes a respective one of the lead screws and a respective one of the carriages, each of the three mechanical actuation cables is a flexible driveshaft. Each of the flexible driveshafts is mechanically associated with one of the lead screws, respectively.

According to some embodiments of the dental device, wherein the turbine maneuvering infrastructure includes the three linear guiding assemblies, and wherein each of the linear guiding assemblies includes a respective one of the carriages and a hydraulic piston mechanically associated with the carriage, each of the three mechanical actuation cables is a hydraulic flexible tube. Each of the hydraulic flexible tubes is fluidly associated with one of the hydraulic pistons, respectively.

According to some embodiments of the dental device, the CNC machine is configured to be controllably affixed to the anchoring member in any one of a plurality of different orientations.

According to some embodiments of the dental device, the CNC machine is removably mountable on the anchoring member.

According to some embodiments of the dental device, the CNC machine further includes an electric-based actuator, a pneumatic-based actuator, or a flexible driveshaft-based actuator configured to affix the mounting of the CNC machine on the anchoring member, such as to prevent load from being applied onto the teeth of the subject during the affixing of CNC machine to the anchoring member.

According to some embodiments of the dental device, the CNC machine is fixedly mountable on the anchoring member via a ball-and-socket joint, a three-axis hexapod joint, or a six-axis hexapod joint.

According to some embodiments of the dental device, the CNC machine is fixedly mountable or fixedly mounted on the anchoring member via a connecting element. A CNC bulk of the CNC machine—the CNC bulk including the turbine maneuvering infrastructure—is detachable from the connecting element, such as to allow reattaching the CNC bulk to the connecting element in a reproducible manner, wherein an orientation of the dental turbine relative to the anchoring member remains unchanged as compared to prior to the detachment.

According to some embodiments of the dental device, the CNC machine is fixedly mountable or fixedly mounted on the anchoring member via a connecting element. The connecting element, together with the CNC bulk, are detachable from an anchoring member bulk of the anchoring member—the anchoring member bulk including the arched frame, the strap, and the tooth-engaging components. The detachment is such that (i) the CNC bulk remains affixed to the connecting element and (ii) the connecting element together with the CNC bulk are reattachable to the anchoring member bulk in a reproducible manner, wherein an orientation of the dental turbine relative to the anchoring member remains unchanged as compared to prior to the detachment.

According to some embodiments of the dental device, the CNC bulk is attachable to the connecting element via a CNC bulk fastener. The CNC bulk includes a first interlocking component and the connecting element includes a second interlocking component configured to interlock with the first interlocking component, such as to allow reattachment of the CNC bulk to the connecting element in a reproducible manner.

According to some embodiments of the dental device, the anchoring member bulk is attachable to the connecting element via an anchoring member bulk fastener. The anchoring member bulk includes a first interlocking component and the connecting element includes a second interlocking component configured to interlock with the first interlocking component, such as to allow reattachment of the anchoring member bulk to the connecting element in a reproducible manner.

According to some embodiments of the dental device, the CNC bulk fastener is screw-based.

According to some embodiments of the dental device, the anchoring member bulk fastener is screw-based.

According to some embodiments of the dental device, the second interlocking component is complementary to the first interlocking component.

According to some embodiments of the dental device, the first interlocking component includes a pin and the second interlocking component includes a complementary hole (i.e. a hole that matches the pin), or wherein the first interlocking component includes a hole and the second interlocking component includes a complementary pin.

According to some embodiments of the dental device, the connecting element is, or includes, a ball-and-socket joint, a three-axis hexapod joint, or a six-axis hexapod joint, configured to allow controllably changing an orientation of the CNC machine relative to the anchoring member.

According to some embodiments of the dental device, the CNC machine is configured to operate the dental turbine in a tactile imaging mode, wherein a headpiece installed on the tip of the dental turbine probes a surface of a tooth to obtain data indicative of a structure of the tooth. The headpiece may be a drill bit or a tactile probe.

According to some embodiments of the dental device, the dental device further includes an electrical transducer mechanically associated with the headpiece and configured to convert a tooth morphology into electrical signals.

According to some embodiments of the dental device, the dental device further includes an imager configured to obtain data indicative of a structure of a tooth.

According to some embodiments of the dental device, the imager is further configured to obtain additional data indicative of a distance between the tooth and the dental turbine and/or of an orientation of the tooth relative to the dental turbine.

According to some embodiments of the dental device, the imager includes one or more of (i) a 3D scanner and (ii) a camera(s), and, optionally, one or more mirrors.

According to some embodiments of the dental device, the 3D scanner is optical-based.

According to some embodiments of the dental device, the imager is positioned on the device such as to allow scanning, and/or obtaining photos of, at least a part of the tooth together with at least three locations on the CNC machine, the three locations being fixed relative to one another and defining a triangle.

According to some embodiments of the dental device, CNC machine coordinates of each of the three locations are known.

According to some embodiments of the dental device, the three locations are positioned on the distal portion of the dental turbine and/or on a dedicated headpiece.

According to some embodiments of the dental device, the anchoring member includes an arched frame and at least three tooth-engaging components mounted on the arched frame. The tooth-engaging components are configured such that, when the anchoring member is properly (correctly) affixed to a jaw of a subject, each of the tooth-engaging components is coupled to a respective at least one tooth.

According to some embodiments of the dental device, the at least one tooth includes at least the mandibular molars, pre-molars, and canines. At least some of the tooth-engaging components are maneuverable such as to enable coupling thereof to selected teeth from a respective plurality of mandibular teeth, thereby allowing to apply the at least one dental-shaping procedure to at least any one of the mandibular molars, pre-molars, and canines.

According to some embodiments of the dental device, the at least one tooth includes at least maxillary molars, pre-molars, and canines. At least some of the tooth-engaging components are maneuverable such as to enable coupling thereof to selected teeth from a respective plurality of maxillary teeth, thereby allowing to apply the at least one dental-shaping procedure to at least any one of the maxillary molars, pre-molars, and canines.

According to some embodiments of the dental device, the arched frame includes a base and two arms.

According to some embodiments of the dental device, when the anchoring member is properly affixed to the jaw of the subject, each of the two arms is positioned adjacently to a respective cheek of the subject.

According to some embodiments of the dental device, the anchoring member includes a strap configured to be adjustably tightly fastened about a head of a subject.

According to some embodiments of the dental device, the dental device is configured to be affixed to a lower jaw of the subject and the at least one tooth includes a mandibular tooth, and wherein the strap is configured to be fastened about a chin of the subject, and/or the dental device is configured to be affixed to an upper jaw of the subject and the at least one tooth includes a maxillary tooth, and wherein the strap is configured to be fastened about a scalp of the subject.

According to some embodiments of the dental device, the tooth-engaging components include a first elongated rod and a second elongated rod. Each of the elongated rods includes a rod body and a tip element at or near a distal end of the rod body. The tip element is configured to securely engage a groove on a tooth or a projection on a tooth. Each of the elongated rods is configured to be mounted on the arched frame between the two arms of the arched frame, such that, when the anchoring member is properly affixed to the jaw of the subject, a distal portion of the elongated rod is positioned within the oral cavity of the subject. Each of the elongated rods is maneuverable relative to the arched frame, such as to allow the respective tip element to engage a respective selected tooth. Each of the elongated rods is associated with a respective locking mechanism configured to controllably affix the elongated rods relative to the arched frame, such that the tooth-engagement provided by each of the tip elements is secure.

According to some embodiments of the dental device, the arched frame includes two mounting holes wherethrough the two elongated rods are respectively mountable.

According to some embodiments of the dental device, each of the locking mechanisms is screw-based.

According to some embodiments of the dental device, at least some of the tip elements include a conically-shaped tip which extends perpendicularly to, or substantially perpendicularly to, the respective rod body, the tip being configured to engage a groove on an occlusal surface of a tooth, and/or at least some of the tip elements include a tip including a concave depression, the tip extending perpendicularly to, or substantially perpendicularly to, the respective rod body, the tip being configured to engage a projection on an occlusal surface of a tooth.

According to some embodiments of the dental device, each concave depression is configured to be precisely fitted on the respective projection. For example, each concave depression may be 3D-printed based on 3D scan data of the respective projection, such that each concave depression is shaped as a “negative” of the projection.

According to some embodiments of the dental device, the elongated rods, are configured such that, when the anchoring member is properly affixed to the jaw of the subject, the first elongated rod is positioned proximately to right side-teeth such as to push away from the right side-teeth inner tissue of a right cheek of the subject, and the second elongated rod is positioned proximately to left side-teeth such as to push away from the left side-teeth inner tissue of a left cheek of the subject.

According to some embodiments of the dental device, each of the tip elements further includes a stem. Each of the stems includes one of the tips, respectively, positioned thereon and perpendicularly, or substantially perpendicularly, thereto. The stem projects at an angle relative to the respective rod body. When the anchoring member is properly affixed to the jaw of the subject, the first elongated rod and the second elongated rod are positioned proximately to the right side-teeth and the left side-teeth, respectively, such that (i) the rod body of the first elongated rod is positioned to the right of the right-side teeth, and the stem of the first elongated rod projects leftwards from the rod body towards the right-side teeth, thereby leaving at least some of the right-side teeth accessible to the dental turbine, and/or (ii) the rod body of the second elongated rod is positioned to the left of the left-side teeth, and the stem of the second elongated rod projects rightwards from the rod body towards the left-side teeth, thereby leaving at least some of the left-side teeth accessible to the dental turbine.

According to some embodiments of the dental device, the tooth-engaging components include a central tooth-engaging component configured to engage one or more of front teeth of the subject.

According to some embodiments of the dental device, when the anchoring member is properly affixed to the jaw of the subject, each of the two arms is inserted into an oral cavity of the subject, such as to surround a set of mandibular teeth or a set of maxillary teeth of the subject.

According to some embodiments of the dental device, the dental device is further configured such that, when the anchoring member is properly affixed to a jaw of a subject, each of the tooth-engaging components is pressed against a respective tooth.

According to some embodiments of the dental device, the tooth-engaging components are removably mountable on the arched frame, optionally, along different locations on the arched frame.

According to some embodiments of the dental device, the tooth-engaging components are shiftable (movable) along the arched frame.

According to an aspect of some embodiments, there is provided a system for shaping a tooth. The system includes the dental device described above, and a processing circuitry including a processor and a memory. The processing circuitry is configured to:
Receive from the imager, and/or the CNC machine, data indicative of a structure of a tooth, and, optionally, additional data indicative of a distance between the tooth and the dental turbine and an orientation of the dental turbine relative to the tooth.
Provide tooth-shaping instructions to the CNC machine based on the received data and a selected tooth shape.

According to some embodiments of the system, the additional data is indicative of a distance between the tooth and a distal portion of the dental turbine and an orientation of the distal portion relative to the tooth.

According to some embodiments of the system, the processing circuitry is further configured to provide instructions for grinding the tooth such that the ground tooth is configured to receive a dental crown.

According to some embodiments of the system, the CNC machine further includes the controller described above. The controller is configured to receive from the processing circuitry the tooth shaping instructions, and to relay the data from the imager to the processing circuitry.

According to some embodiments of the system, wherein, as described above, the CNC machine includes the turbine maneuvering infrastructure configured to allow controllably moving at least the distal portion of the dental turbine along each of three independent directions and/or arcs, and wherein, as described above, the turbine maneuvering infrastructure is configured to be mechanically coupled to the mechanical actuation unit, the mechanical actuation unit being configured to cause the turbine maneuvering infrastructure to move at least the distal portion of the dental turbine, the system further includes the mechanical actuation unit.

According to some embodiments of the system, wherein, as described above, the turbine maneuvering infrastructure is configured to be mechanically coupled to the mechanical actuation unit via the three mechanical actuation cables, each of the mechanical actuation cables being configured to induce motion of at least the distal portion of the dental turbine along each of the three independent directions and/or arcs, respectively, the system further includes the three mechanical actuation cables.

According to an aspect of some embodiments, there is provided a method for shaping a tooth of a subject. The method includes stages of:
Providing a dental device and a processing circuitry functionally associated with the dental device. The dental device includes a computerized numerical control (CNC) machine configured to control operation of a dental turbine, installed on the CNC machine.
Removably affixing the dental device to a jaw of a subject such that the dental device remains stationary with respect to a set of teeth of a subject.
Obtaining coordinates of a plurality of locations along a margin line on a surface of a tooth from the set of teeth and coordinates of an apex of the tooth, wherein the margin line demarcates a part of the tooth which is to be shaped, and wherein the coordinates are specified in terms of a CNC machine coordinate system.
Utilizing the processing circuitry to (i) specify, in terms of the CNC machine coordinate system, a part of the tooth, which is to remain after the shaping of the tooth, based on the obtained coordinates, and (ii) generate tooth-shaping instructions for the CNC machine, based on the specification of the part of the tooth.
Utilizing the CNC machine to shape the tooth, based on the generated tooth-shaping instructions.

According to an aspect of some embodiments of the method, the method further includes utilizing an imager to acquire data indicative of a structure of the tooth, and analyzing the acquired data to obtain therefrom the coordinates of the plurality of locations along the margin line and of the apex.

According to an aspect of some embodiments of the method, the imager includes one or more of a 3D scanner, a camera(s), and a tactile probe.

According to an aspect of some embodiments of the method, the acquired data is analyzed using the processing circuitry.

According to an aspect of some embodiments of the method, the 3D scanner is optical-based.

According to an aspect of some embodiments of the method, the method further includes, prior to the stage of obtaining coordinates:
Marking the plurality of locations along the margin line and the apex.
Utilizing the camera to obtain images of the tooth from a plurality of different angles, said images of the tooth constituting the acquired data indicative of the structure of the tooth.

According to an aspect of some embodiments of the method, the method further includes using mirrors to provide different angle views of the tooth for the camera.

According to an aspect of some embodiments of the method, the processing circuitry is utilized to analyze the images of the tooth in order to obtain the coordinates of the plurality of locations along the margin line and of the apex.

According to an aspect of some embodiments of the method, the analysis of the images of the tooth is performed using image processing software.

According to an aspect of some embodiments of the method, the imager includes a 3D scanner or a camera. The method further includes, prior to the stage of obtaining coordinates, imaging the tooth together with three locations on the dental device, such that (i) the three locations define a triangle with corners that are fixed with respect to one another, and (ii) CNC machine coordinates of each of the locations are known.

According to an aspect of some embodiments of the method, the three locations are situated on the dental turbine.

According to an aspect of some embodiments of the method, the plurality of locations along the margin line include at least six locations.

According to an aspect of some embodiments of the method, the shaping of the tooth includes grinding of a tooth in preparation for installing a dental crown on the tooth.

According to some embodiments of the method, the shaping of the tooth may include grinding of a tooth in preparation for installing a dental inlay, onlay, or overlay on the tooth.

According to an aspect of some embodiments of the method, the grinding of the tooth is performed utilizing a drill bit installable on the dental turbine.

According to an aspect of some embodiments of the method, the drill bit is configured to be translated along at least three independent axes, such that an amount of translation along each axis is independent of the amount of translation along each of the other axes.

According to an aspect of some embodiments of the method, the dental device is adjustable such as to allow the securing thereof to jaws of different subjects.

According to an aspect of some embodiments of the method, when the dental device is affixed to the jaw, the dental device is supported by the subject.

According to an aspect of some embodiments of the method, the set of teeth consists of mandibular teeth and the dental device is configured to be affixed to a lower jaw of the subject, or the set of teeth consists of maxillary teeth and the dental device is configured to be affixed to an upper jaw of the subject.

According to an aspect of some embodiments of the method, the dental device further includes an anchoring member whereby the dental device is removably affixed to the jaw of the subject. The CNC machine is detachably fixedly mountable on the anchoring member.

According to an aspect of some embodiments of the method, the CNC machine is fixedly mountable on the anchoring member, via a connecting element, such as to allow orienting the dental turbine relative to the anchoring member. A bulk of the CNC machine is detachable from the connecting element, such as to allow reattachment of the of the bulk of the CNC machine to the connecting element in a reproducible manner.

According to some embodiments of the method, in the stage of removably affixing the dental device, 3D scan data of teeth, to which the dental device is to be secured, may be utilized to assist in affixing the dental device.

According to some embodiments of the method, the dental device may be removably affixed to the jaw of the subject, in an iterative manner based on/also based on tactile sensation (e.g. of the dentist).

According to an aspect of some embodiments, there is provided a method for shaping at least two teeth of a subject in preparation for installing thereon a dental bridge. The method includes performing the above-described method with respect to each of the at least two teeth, such that the dental device is affixed only once, a single orientation of the CNC machine relative to the anchoring member is utilized, and:
For each tooth of the at least two teeth, CNC machine coordinates of a respective plurality of locations along a margin line on a surface of the tooth, and of a respective apex of the tooth, are obtained.
The processing circuitry is utilized to (i) specify, in terms of the CNC machine coordinate system, respective parts of the at least two teeth, which are to remain after the shaping of each of the at least two teeth, based on the obtained CNC machine coordinates, and (ii) generate teeth-shaping instructions for the CNC machine, based on the specification of the parts of the at least two teeth.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types.

Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1 presents a schematic perspective view of a dental device for shaping teeth, which is configured to be affixed to, and supported on, a jaw of a subject, the dental device includes an anchoring member, a CNC machine, and a dental turbine, according to some embodiments;

FIGS. 2A-2C present schematic perspective views of the anchoring member of FIG. 1, according to some embodiments;

FIG. 3A presents a schematic perspective cutaway view of a head of a subject with the anchoring member of FIG. 1 affixed to a lower jaw of the subject, according to some embodiments;

FIG. 3B presents a schematic perspective cutaway view of a head of a subject with the dental device of FIG. 1 affixed to a lower jaw of the subject, according to some embodiments;

FIG. 3C presents a schematic perspective view of four left mandibular teeth with a tooth-engaging component of the anchoring member of FIG. 1 engaging one of the teeth, according to some embodiments;

FIG. 3D presents a schematic perspective view of the dental device of FIG. 1 in which the anchoring member is shown engaging mandibular teeth of a subject, according to some embodiments;

FIG. 3E presents a schematic perspective view of a head of a subject with an anchoring member, which is similar to the anchoring member of the dental device of FIG. 1, and which is affixed to an upper jaw of the subject, according to some embodiments;

FIG. 3F presents a schematic perspective view of a head of a subject and a dental device, which includes the anchoring member of FIG. 3E, affixed to an upper jaw of the subject, according to some embodiments;

FIG. 4A presents a schematic perspective view of the CNC machine of FIG. 1, according to some embodiments;

FIG. 4B presents a schematic (partial) perspective view of the CNC machine of FIG. 1, according to some embodiments;

FIG. 4B presents a schematic (partial) perspective view of the CNC machine of FIG. 1, with a bulk of the CNC machine detached, according to some embodiments;

FIG. 5A presents a schematic perspective view of the dental turbine of FIG. 1 with a drill bit mounted thereon, according to some embodiments;

FIG. 5B presents a schematic perspective view of a distal portion of the dental turbine of FIG. 1 with a tactile probe mounted thereon, according to some embodiments;

FIG. 6 presents a schematic (partial) perspective view of a dental device for shaping teeth, which is similar to the dental device of FIG. 1, but which varies therefrom in including a non-manual locking mechanism for controllably affixing a CNC machine of the dental device to an anchoring member thereof, according to some embodiments;

FIG. 7 presents a schematic perspective view of a dental device for shaping teeth and an actuator, the dental device is similar to the dental device of FIG. 1 but differs therefrom in that a CNC machine of the dental device does not include motors, being instead mechanically associated with the actuator which is configured to mechanically actuate the CNC machine, according to some embodiments;

FIGS. 8A and 8B present schematic perspective views of an anchoring member for a dental device for shaping teeth, according to some embodiments;

FIGS. 9A-9C present schematic perspective views of an anchoring member for a dental device for shaping teeth, according to some embodiments;

FIG. 10 presents a flowchart of a dental method for shaping teeth, according to some embodiments;

FIG. 11 presents a schematic perspective view of a tooth to be shaped using the method of FIG. 10, also indicated is a margin line demarcating a part of the tooth that is to be shaped, according to some embodiments;

FIG. 12 presents a schematic (partial) perspective view of the dental device of FIG. 1 affixed to a lower jaw of a subject, and an indicator member, which is mounted on the CNC machine, inserted into the oral cavity of the subject, according to some embodiments; and

FIGS. 13A and 13B present a flowchart of a dental method for shaping teeth, which is a specific embodiment of the dental method of FIG. 10.

### DETAILED DESCRIPTION

The principles, uses, and implementations of the teachings herein may be better understood with reference to the accompanying description and figures, which are to be considered part of the entire written description. Upon perusal of the description and figures present herein, one skilled in the art will be able to implement the teachings herein without undue effort or experimentation. In the figures, same reference numerals refer to same parts throughout.

In the description of embodiments disclosed herein, any reference to direction or orientation is merely intended to facilitate the description and is not intended in any way to limit the scope of the present disclosure. Relative terms such as “lower”, “upper”, “horizontal”, “vertical”, “above”, “below”, “up”, “down”, “top”, and “bottom”, as well as derivatives thereof (e.g., “horizontally”, “downwardly”, “upwardly”, etc.) should be construed to refer to the orientation as then described or as shown in the figure under discussion, unless stated to the contrary or the context implicitly dictates otherwise. These relative terms are used for convenience of description only and do not require that the apparatus be constructed or operated in a particular orientation unless explicitly indicated as such.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

Dental Devices and Systems

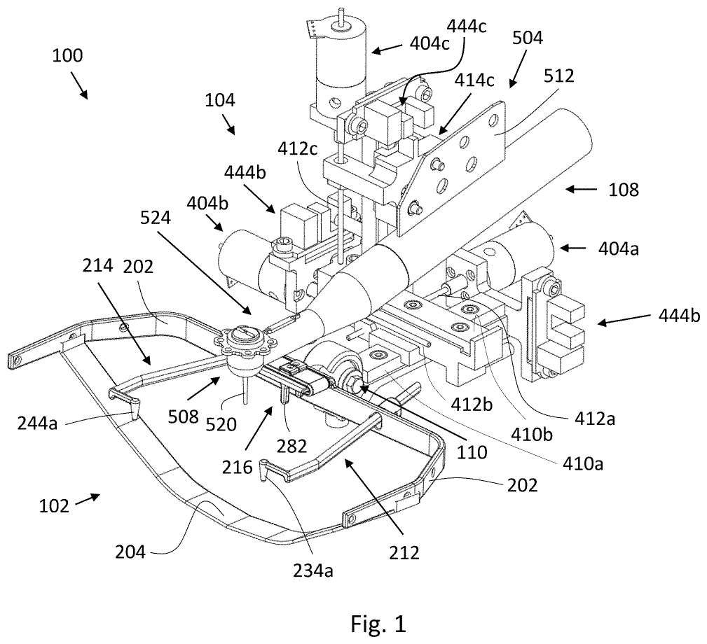

Referring to FIGS. 1-3D and 4-5B, according to an aspect of some embodiments, there is provided a dental device 100 for shaping teeth of a subject (i.e. patient), which is configured to be affixed to, and supported on, a jaw of the subject. FIG. 1 is a schematic perspective view of dental device 100, according to some embodiments. Dental device 100 includes an anchoring member 102 and a computerized numerical control (CNC) machine 104. As elaborated on below, anchoring member 102 is configured to be removably affixed to a jaw of a subject by securing anchoring member 102 to a plurality of teeth of the subject. Anchoring member 102 may be adjustable such as to allow the securing (affixing) thereof to jaws of different sizes, shapes, and anatomies (being thereby adaptable to jaws of different subjects). CNC machine 104 is configured to have installed thereon a dental turbine 108. CNC machine 104 is further configured to autonomously control operation of dental turbine 108 in at least one dental tooth-shaping procedure on at least one tooth of the subject, as elaborated on below.

The at least one dental tooth-shaping procedure may include grinding of a tooth in preparation for installing on the ground tooth (i.e. the processed tooth after the grinding) a dental crown. Further, the at least one dental tooth-shaping procedure may include grinding of two or more teeth in preparation for installing a dental bridge thereon. According to some embodiments, the at least one dental tooth-shaping procedure may include/additionally include preparation for installing dental inlays, onlays, and/or overlays.

According to some embodiments, CNC machine 104 is removably mountable on anchoring member 102. Anchoring member 102 and CNC machine 104 are configured such that (once CNC machine 104 is mounted on anchoring member 102) CNC machine 104 may be controllably affixed (secured) to anchoring member 102 in the sense that relative motion there between is blocked, or, more precisely, relative motion between a base of anchoring member and a base of CNC machine 104 is blocked. In particular, the affixing of CNC machine 104 to anchoring member 102 may be such that when anchoring member 102 is properly (correctly) affixed to the jaw of a subject, dental device 100 is fully supported by the subject. According to some embodiments, and as elaborated on below, dental device 100 includes a ball-and-socket joint 110, configured to allow the controllable affixing of CNC machine 104 to anchoring member 102.

According to some embodiments, and as elaborated on below, CNC machine 104 may be affixed to anchoring member 102 in different orientations.

According to some alternative embodiments, not depicted in the figures, CNC machine 104 may be mechanically coupled to anchoring member 102 via a three-axis hexapod joint or a six-axis hexapod joint, which allows for controllably affixing CNC machine 104 to anchoring member 102 in a range of different orientations.

Alternatively, according to some embodiments, which are not depicted in the figures, CNC machine 104 is permanently affixed to anchoring member 102 or may be affixed to anchoring member 102 only in a single orientation (while still being detachable therefrom). According to some such embodiments, the orientation of dental turbine 108 relative to CNC machine 104 may be controllably varied.

According to some embodiments, and as depicted in the figures, anchoring member 102 is configured to be affixed to a lower jaw of a subject, dental device 100 being thereby configured for treating mandibular teeth. Additionally or alternatively, according to some other embodiments, anchoring member 102 is configured to be affixed to an upper jaw of a subject, dental device 100 being thereby configured for treating maxillary teeth. These two options for affixing anchoring member 102 are described in more detail below.

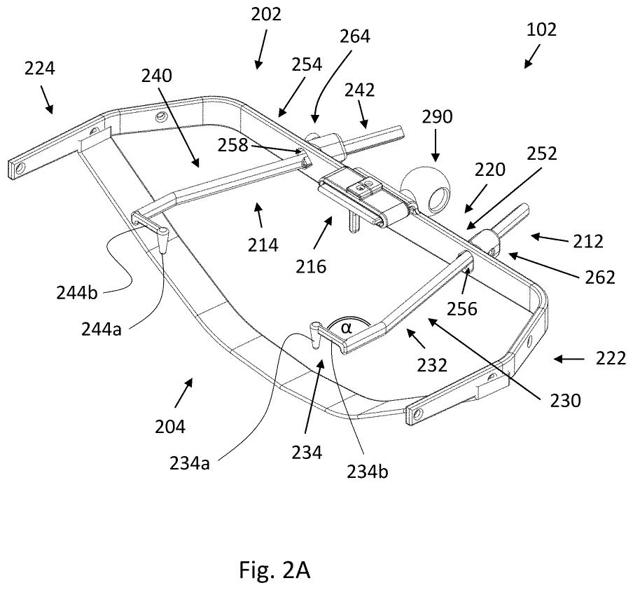

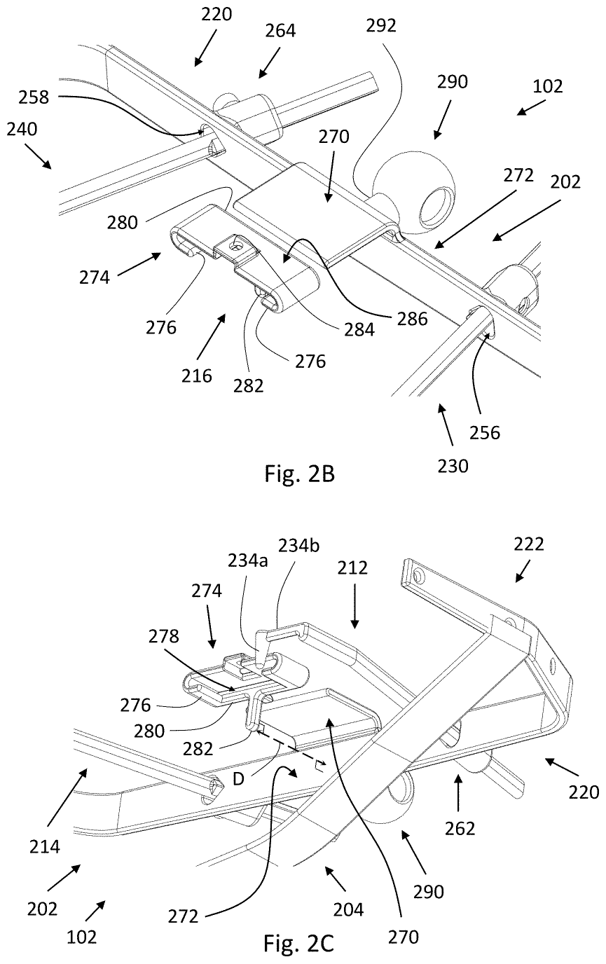

FIG. 2A is a schematic perspective view of anchoring member 102, according to some embodiments. Anchoring member 102 includes an arched frame 202, a strap 204, and a plurality of tooth-engaging components. According to some embodiments, and as depicted in FIG. 2A, the plurality of tooth-engaging components include three tooth-engaging components: a first tooth-engaging component 212, a second tooth-engaging component 214, and a central tooth-engaging component 216 positioned between first tooth-engaging component 212 and second tooth-engaging component 214. Arched frame 202 includes an elongated base 220, a first arm 222, and a second arm 224. Arms 222 and 224 extend from opposite ends of base 220. According to some embodiments, first arm 222 and second arm 224 may be of equal length. FIGS. 2B and 2C schematically depict base 220 and central tooth-engaging component 216.

According to some embodiments, arched frame 202 may be U-shaped, or substantially U-shaped, with base 220 constituting the “lower” part (or basis) of the of “U”. According to some embodiments, arched frame 202 may be shaped similarly to an arc of a circle subtending, for example, an angle of between about 150° and about 210° relative to the center of the circle. According to some embodiments, arched frame 202 may be shaped similarly to an arc of an ellipse. It will be understood that arched frame 202 is said to be arched in a broad sense, which covers not only smoothly curved shapes, but also shapes which may include vertices. Thus, for example, according to some embodiments, arched frame 202 may be shaped similarly to the “square cup” symbol ␣. According to some embodiments, base 220 and arms 222 and 224 may be positioned relative to one another similarly to the shorter of the two bases (i.e. base 220) of a (non-rectangular) trapezoid and the two arms (i.e. arms 222 and 224) of the trapezoid. According to some such embodiments, the trapezoid may be an isosceles trapezoid.

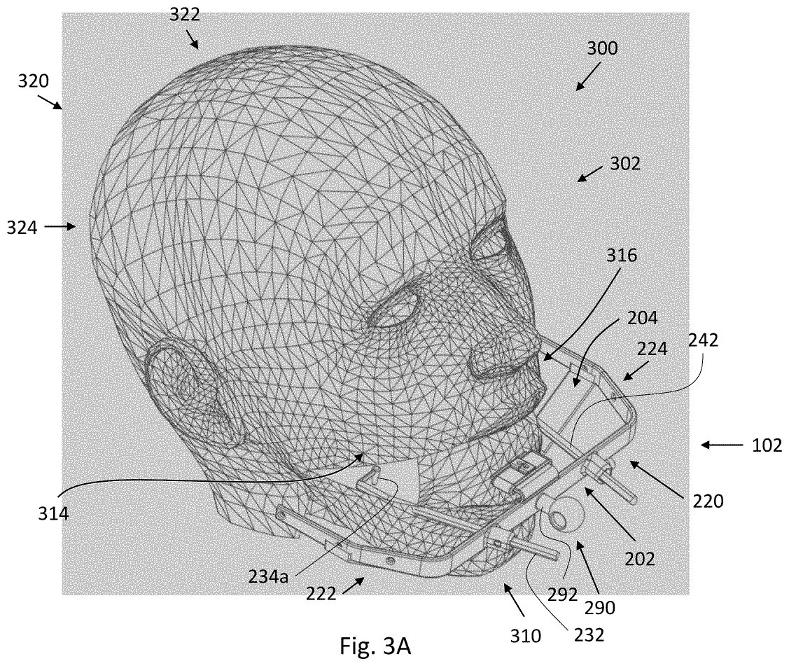

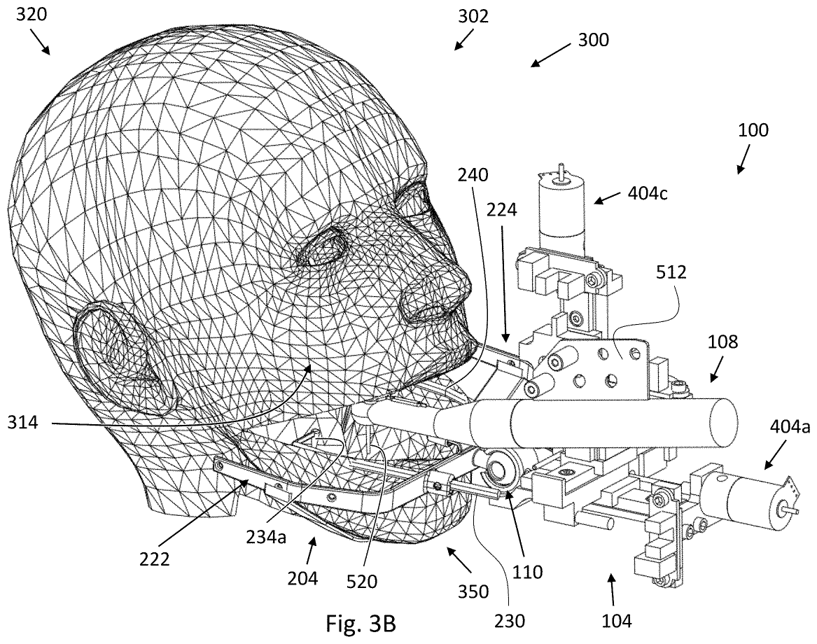

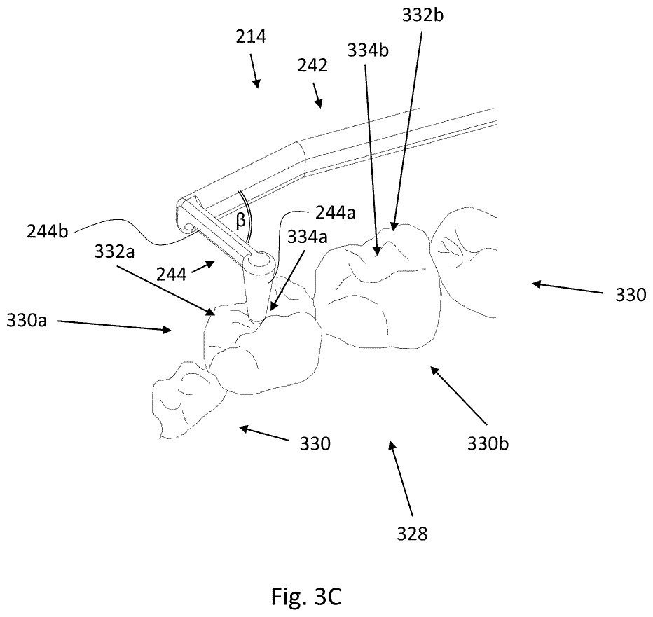

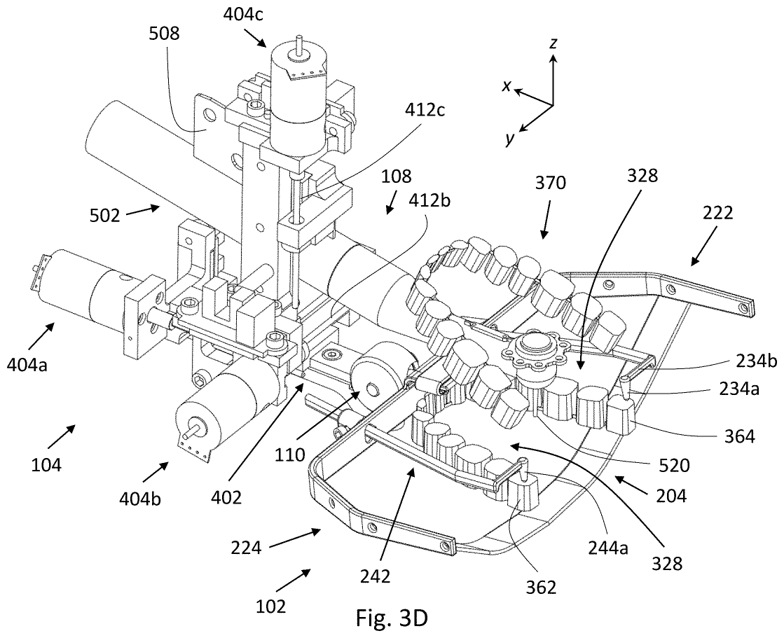

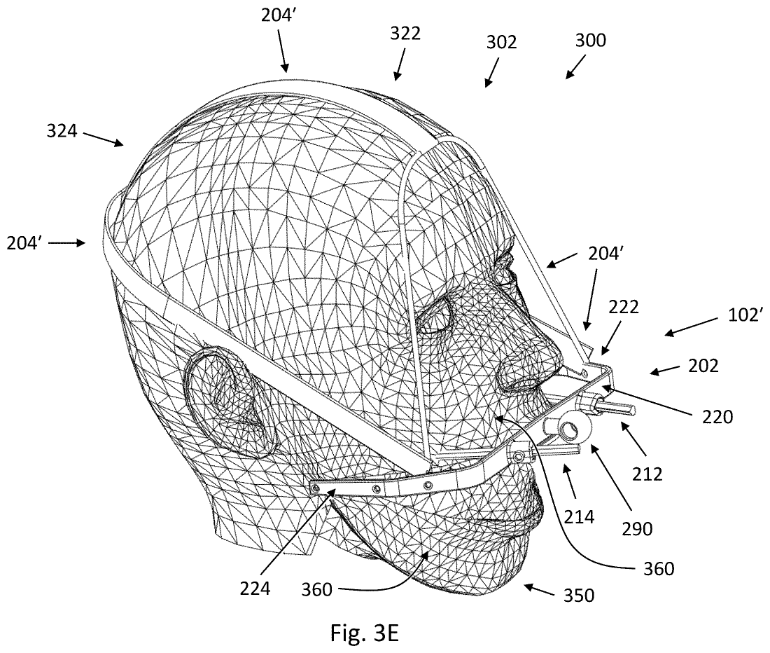

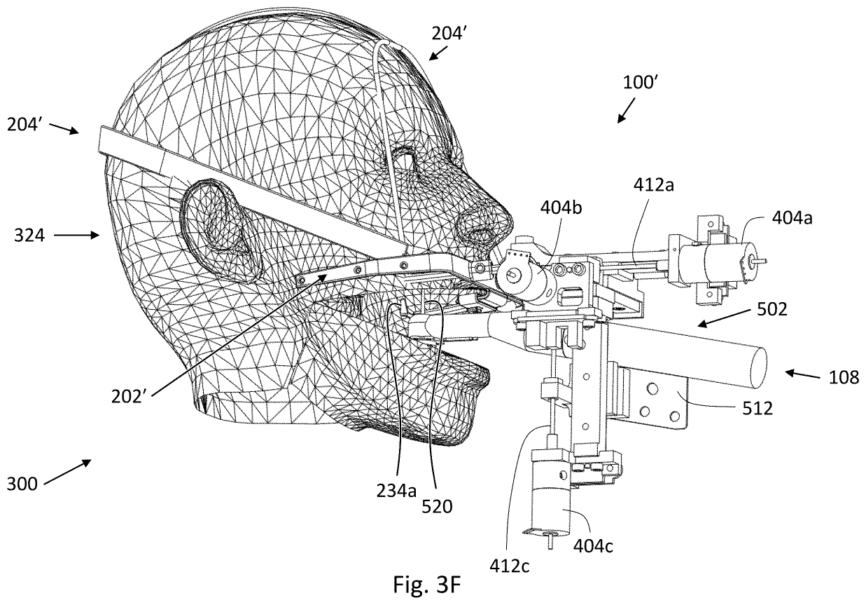

FIG. 3A presents a perspective cutaway view of a head 302 of a subject 300 with anchoring member 102 affixed to a lower jaw 310 of subject 300, according to some embodiments. In FIG. 3B, CNC machine 104 (with dental turbine 108 installed thereon) is additionally shown affixed to anchoring member 102. More specifically, in both FIG. 3A and in FIG. 3B, a right part of the face, below the right cheekbone and to the side of the mouth, and a left part of the face, below the left cheekbone and to the side mouth, have been cut away (removed) to reveal the positioning of tooth-engaging components 212, 214, and 216 within the oral cavity. Further, internal parts, such as the tongue and teeth, are not shown. It is noted that both first arm 222 and second arm 224 are positioned externally to the oral cavity of subject 300, with first arm 222 being positioned adjacently to a right cheek 314 of subject 300, and second arm 224 being positioned adjacently to a left cheek 316 of subject 300.

Also indicated are a scalp 320 of subject 300, a scalp top 322 (i.e. the top or crown of scalp 320), and a scalp back 324 (i.e. the back part of scalp 320).

FIG. 3C shows left mandibular molars 330 (from mandibular teeth 328 of subject 300) of subject 300, with second tooth-engaging component 214 engaging a target molar 330a (from left mandibular molars 330).

As used herein, the terms “left” and “right” in reference to body parts of a subject (e.g. subject 300) are to be accorded the same meaning as in the field of anatomy. That is to say, when used in reference to body parts of a subject, the terms “left” and “right” are defined by the subject, irrespective of the orientation of the subject in any accompanying figure and irrespective of the “left” and “right” of a reader perusing the figure.

As used herein, the terms “distal” and “proximal” in reference to a dental device, such as dental device 100, or parts thereof, should be understood to be defined with respect to the operator of the device (the person operating the device, e.g. the dental surgeon). For example, a first part of a device may be said to be positioned “distally” relative to a second part of the device, when the first part is farther than the second part from the operator of the device. On the other hand, relative anatomical terms such as “medial” and “lateral” are defined by the subject (e.g. subject 300).

FIG. 3D presents a schematic perspective view of dental device 100 securely engaging mandibular teeth 328 of subject 300, according to some embodiments. More specifically, tip 244a is shown engaging a right rearmost mandibular molar 362 and tip 234a is shown engaging a left rearmost mandibular molar 364. Also indicated are maxillary teeth 370.

According to some embodiments, arched frame 202 may be made of, or include, a biocompatible and non-corrosive rigid material including plastics, ceramics, metals, and/or alloys. According to some embodiments, arched frame 202 may be made of, or include, stainless steel, titanium, or cobalt-chrome. According to some embodiments, arched frame 202 may be made of, or include, a composite material. According to some embodiments, arched frame 202 may be produced by casting, sintering, and/or 3D printing. Arched frame 202 may be provided in different sizes to fit different oral cavity geometries and sizes. According to some embodiments, arched frame 202 may be made of a single piece of material, that is, base 220 and arms 222 and 224 may be integrally formed.

Strap 204 is configured to be (tightly) fastened about a chin of a subject (e.g. a chin 350 of subject 300). A first end of strap 204 may be connected to first arm 222 and the second end of strap 204 may be connected to second arm 224. Strap 204 may include a fastener (not shown). According to some embodiments, strap 204 may include two strips of material configured to be fastened to one another. One of the strips may be connected, on an end thereof, to first arm 222, and the other strip, may be connected on an end thereof, to second arm 224. A fastener, such as a ladder lock buckle, may be used to fasten the two strips to one another and to tighten strap 204 about a chin of a subject.

According to some embodiments, first tooth-engaging component 212 includes an elongated first rod 230 configured to be mounted on arched frame 202. First rod 230 includes a rod body 232 and a tip element 234 positioned at, or near, a distal end of rod body 232. Tip element 234 is configured to securely engage a groove (depression) or a dent in a tooth, e.g. on the occlusal (masticatory) surface of the tooth. More specifically, tip element 234 may include a tip 234a configured to be fitted into a groove on the occlusal surface of a molar tooth. According to some embodiments, tip element 234 may further include a stem 234b. Stem 234b may extend from rod body 232 at, or near, the distal end of rod body 232, and at an angle α relative to the longitudinal direction defined by rod body 232. (The longitudinal direction defined by rod body 232 may run parallel to the length of rod body 232.) According to some embodiments, a may measure between about 90° and about 120°. Tip 234a may be positioned at, or near, the end of stem 234b, projecting perpendicularly, or substantially perpendicularly, to stem 234b (and to the plane defined by stem 234b and rod body 232).

Similarly, according to some embodiments, second tooth-engaging component 214 includes an elongated second rod 240 configured to be mounted on arched frame 202. Second rod 240 includes a rod body 242 and a tip element 244 positioned at, or near, a distal end of rod body 242. Tip element 244 is configured to securely engage a groove or a dent in a tooth. More specifically, tip element 244 may include a tip 244a configured to engage a groove on an occlusal surface of a molar tooth. According to some embodiments, tip element 244 may further include a stem 244b. Stem 244b may extend from rod body 242 at, or near, the distal end of rod body 242, and at an angle β (indicated in FIG. 3C) relative to the longitudinal direction defined by rod body 242. According to some embodiments, β may measure between about 90° and about 120°. According to some embodiments, α and β may be equal. Tip 244a may be positioned at, or near, the end of stem 244b, projecting perpendicularly, or substantially perpendicularly, to stem 244b (and to the plane defined by stem 244b and rod body 242).

According to some embodiments, tip elements 234 and 244 may be configured to engage/also engage grooves or dents on an exposed filling, or on an existing dental crown, and/or on a broken tooth.

According to some embodiments, tips 234a and 244a may be conical. According to some embodiments, tips 234a and 244a may be curved such as to engage grooves on side-surfaces (e.g. facial surfaces) of teeth.

According to some embodiments, not depicted in the figures, one or more of tip elements 234 and 244 may be concave in the sense of including a depressed surface configured to engage a projection in a target tooth.

Referring again also to FIG. 3C, tip 244a (of second rod 240) is shown fitted in (engaging) a groove 334a on an occlusal surface 332a of target molar 330a. Also indicated is a groove 334b on an occlusal surface 332b of a second molar 330b (from left mandibular molars 330). It is to be understood that tip 244a may be shaped and dimensioned such as to allow engaging any molar from the left mandibular molars (as long as the molar can support sufficient levels of mechanical loads) Similarly, tip 234a may be shaped and dimensioned such as to allow engaging any molar from the right mandibular molars, as long as the molar can support sufficient levels of mechanical loads.

First tooth-engaging component 212 and second tooth-engaging component 214 may be mounted on arched frame 202. According to some embodiments, first tooth-engaging component 212 may be mounted on a first side-section 252 of base 220, and second tooth-engaging component 214 may be mounted on a second side-section 254 of base 220.

According to some embodiments, and as depicted in the figures, first side-section 252 may include a first mounting hole 256 wherethrough rod body 232 is mounted, and second side-section 254 may include a second mounting hole 258 wherethrough rod body 242 is mounted.

According to some embodiments, anchoring member 102 may include a first locking mechanism 262 and a second locking mechanism 264. First locking mechanism 262 is configured to controllably affix first rod 230 in first mounting hole 256, and second locking mechanism 264 to controllably affix second rod 240 in second mounting hole 258.

According to some embodiments, and as depicted in the figures, first locking mechanism 262 and second locking mechanism 264 may be screw-based. (It is noted that in the figures, the screw of first locking mechanism 262 is not shown in order to reveal the corresponding screw-hole.) When first locking mechanism 262 is unlocked, first rod 230 may be longitudinally shifted (distally pushed or proximally pulled) through first mounting hole 256, thereby allowing to change the distance between tip element 234 (and, in particular, tip 234a) and base 220. That is to say, first rod 230 may be shifted along a first longitudinal axis (not indicated), which is perpendicular to first mounting hole 256. According to some embodiments, when first locking mechanism 262 is unlocked, first rod 230 may be rotated about the first longitudinal axis. Finally, according to some embodiments, when first locking mechanism 262 is unlocked, first rod 230 may further be tilted relative to the first longitudinal axis. As a non-limiting example, according to some embodiments, first rod 230 may be tilted along any direction to pointing to within about 10° from the first longitudinal axis.

Similarly, when second locking mechanism 264 is unlocked, second rod 240 may be longitudinally shifted through second mounting hole 258, thereby allowing to change the distance between tip element 244 (and, in particular, tip 244a) and base 220. That is to say, second rod 240 may be shifted along a second longitudinal axis (not indicated), which is perpendicular to second mounting hole 258. According to some embodiments, when second locking mechanism 264 is unlocked, second rod 240 may be rotated about the second longitudinal axis. Finally, according to some embodiments, when second locking mechanism 264 is unlocked, second rod 240 may further be tilted relative to the second longitudinal axis. As a non-limiting example, according to some embodiments, second rod 240 may be tilted along any direction pointing to within about 10° from the second longitudinal axis.

Referring again to FIGS. 2B and 2C, according to some embodiments and as depicted in the figures, base 220 includes a thin ledge-like element 270 distally projecting from a central section 272 (positioned between first side-section 252 and second side-section 254). Central tooth-engaging component 216 may be slidably mountable on ledge-like element 270. More specifically, central tooth-engaging component 216 includes a main body 274 including flanges 276 and a slot 278 which are shaped and dimensioned such as to allow main body 274 to be slidably received on ledge-like element 270. According to some embodiments, slot 278 is defined by a proximal edge 280 of main body 274. According to some embodiments, a stub 282 may project downwards from a lower part of proximal edge 280. According to some embodiments, stub 282 may project from a center point, or substantially a center point, of the lower part of proximal edge 280.

Central tooth-engaging component 216 may further include a locking mechanism configured to affix main body 274 on ledge-like element 270 (and thereby affix central tooth-engaging component 216 to arched frame 202). As elaborated on below, the locking mechanism may be configured to allow affixing main body 274 to ledge-like element 270 across a range of desired distances between stub 282 and (an inner surface of) central section 272 (of base 220). To facilitate the description, in FIG. 2C, a double-headed arrow D indicates the distance between stub 282 and central section 272. (It should be noted that the distance indicated by the double-headed arrow D is greater than any in the range of desired distance between stub 282 and central section 272, since in FIG. 2C central tooth-engaging component 216 is not mounted on ledge-like element 270).

As a non-limiting example, according to some embodiments, the locking mechanism includes a hole 284 (e.g. a threaded hole) on a top surface 286 of main body 274, wherethrough a screw (not shown) may be threaded, such as to affix central tooth-engaging component 216 to ledge-like element 270.

According to some embodiments, central tooth-engaging component 216 may, in addition, be slidably mountable on ledge-like element 270 in an opposite sense to that depicted in FIGS. 2B and 2C. The extra freedom provided by the option of mounting central tooth-engaging component 216 in two opposite senses increases the range of distances between stub 282 and central section 272 at which central tooth-engaging component 216 may be affixed to ledge-like element 270.

According to some embodiments, to affix anchoring member 102 to lower jaw 310, anchoring member 102 may first be positioned such that ledge-like element 270 rests on the mandibular incisors, with first arm 222 extending adjacently to right cheek 314, second arm 224 extending adjacently to left cheek 316, strap 204 loosely fastened about chin 350, and first rod 230 and second rod 240 (or more precisely, distal sections thereof) inserted into the oral cavity of the subject.

Central tooth-engaging component 216 may then be slid in the proximal direction, such that the two central mandibular incisors are engaged by the inner surface of base 220 (and, more precisely, the inner surface of central section 272) as well as by stub 282. In particular, the positioning of anchoring member 102 on lower jaw 310 may be chosen such that stub 282 equally engages the (backs) of the two central mandibular incisors or the inner edges thereof when a gap is present between the two central mandibular incisors. Central tooth-engaging component 216 may then be affixed to ledge-like element 270 (e.g. by threading a screw through hole 284 on top surface 286 of central tooth-engaging component 216), thereby securing the mandibular incisors between base 220 and central tooth-engaging component 216.

To engage a target tooth (i.e. a right mandibular molar or pre-molar), first tooth-engaging component 212 may be longitudinally maneuvered in first mounting hole 256 (e.g. pushed therethrough) such as to position tip 234a in a groove on the occlusal surface of the target tooth, at which point first locking mechanism 262 may be locked. Similarly, to engage a target tooth (i.e. a left mandibular molar or pre-molar), second tooth-engaging component 214 may be longitudinally maneuvered in second mounting hole 258 such as to position tip 244a in a groove on the occlusal surface of the target tooth, at which point second locking mechanism 264 may be locked.

Once each of tips 234a and 244a are each fitted in the respective groove (and the mandibular incisors are secured between base 220 and central tooth-engaging component 216), strap 204 may be fastened, thereby pushing tips 234a and 244a against the respective target teeth and affixing anchoring member 102 to lower jaw 310.

According to some embodiments, first rod 230 is shaped and dimensioned such that, when anchoring member 102 is properly affixed to lower jaw 310, rod body 232 is positioned adjacently to, and laterally to, the right mandibular molars and pre-molars, such as to push away therefrom tissue of right cheek 314, thereby leaving space for the right mandibular teeth to be treated. According to some such embodiments, stem 234b may medially extend from rod body 232, thereby allowing tip 234a to engage a target right mandibular molar. Similarly, according to some embodiments, second rod 240 is shaped and dimensioned such that, when anchoring member 102 is properly affixed to lower jaw 310, rod body 242 is positioned adjacently to, and laterally to, the left mandibular molars and pre-molars, such as to push away therefrom tissue of left cheek 316, thereby leaving space for the left mandibular teeth to be treated. According to some such embodiments, stem 244b may medially extend from rod body 242, thereby allowing tip 244a to engage a target tooth from the right mandibular molars.

According to some embodiments, base 220 may have mounted thereon, on a proximal surface thereof, a ball 290, which constitutes the ball from ball-and-socket joint 110. A neck element 292 (indicated in FIGS. 2B and 3A) may connect ball 290 to base 220. It is noted that neck element 292 is of a width which is smaller than the diameter of ball 290. As described below, CNC machine 104 includes a matching a socket whereby CNC machine 104 may be affixed to anchoring member 102. According to some alternative embodiments, not depicted in the figure, base 220 may have attached thereto a socket and CNC machine 104 may have attached thereto a matching ball, which together with the socket constitute a ball-and-socket joint configured to affix CNC machine 104 on anchoring member 102.

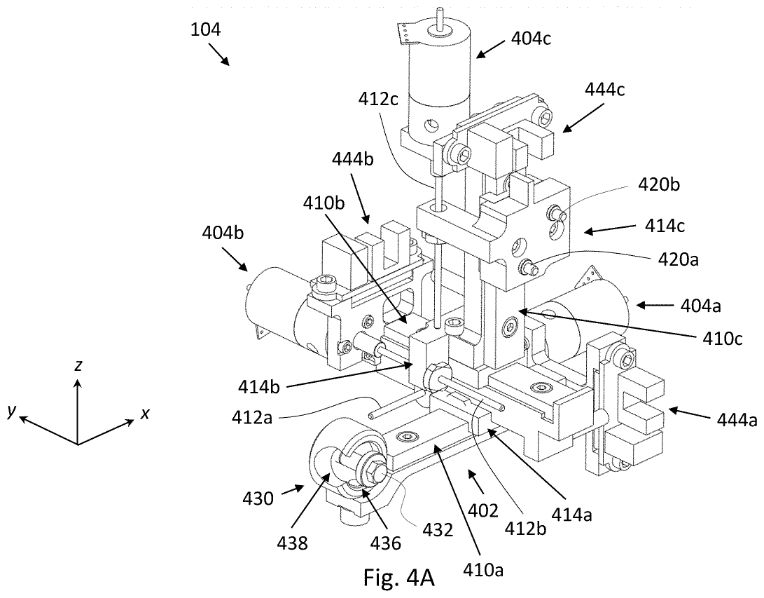

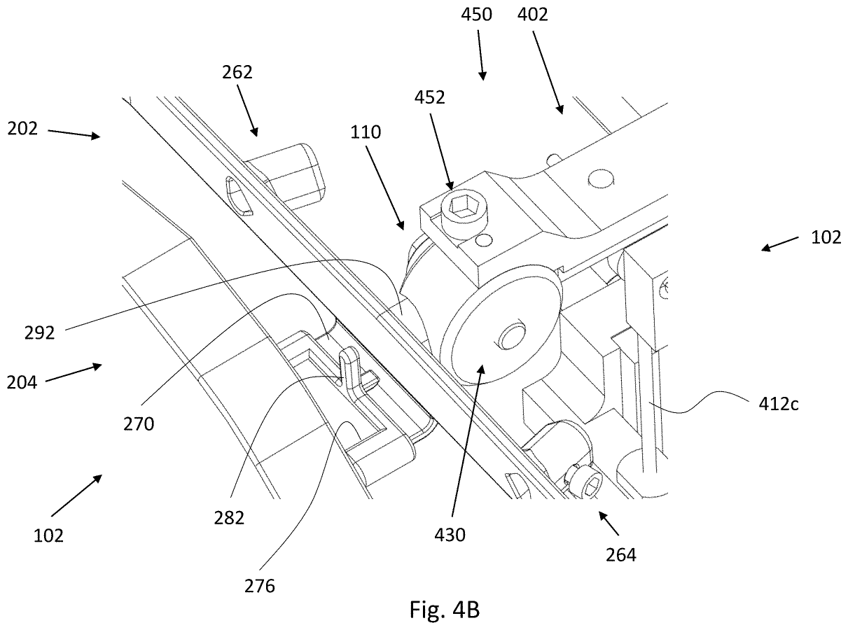

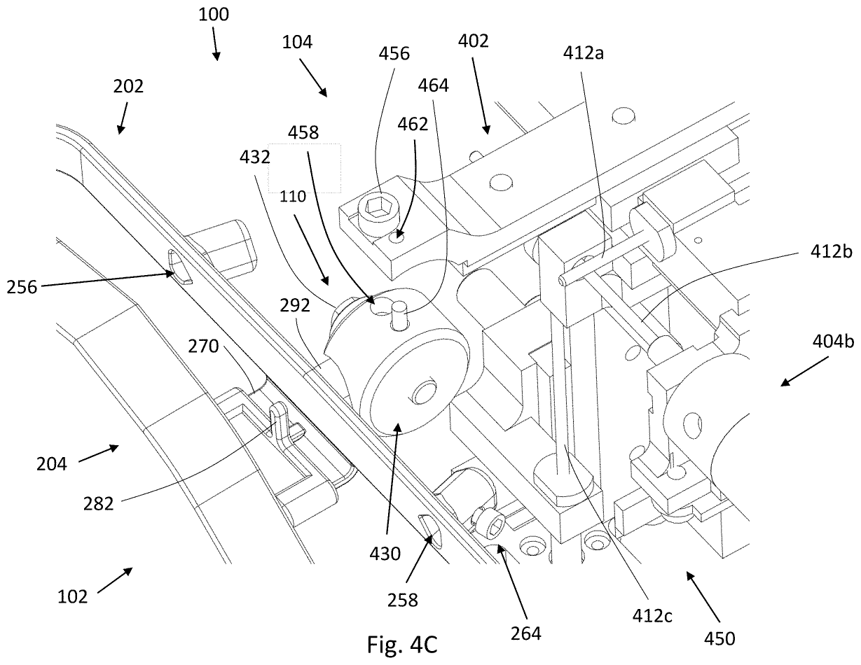

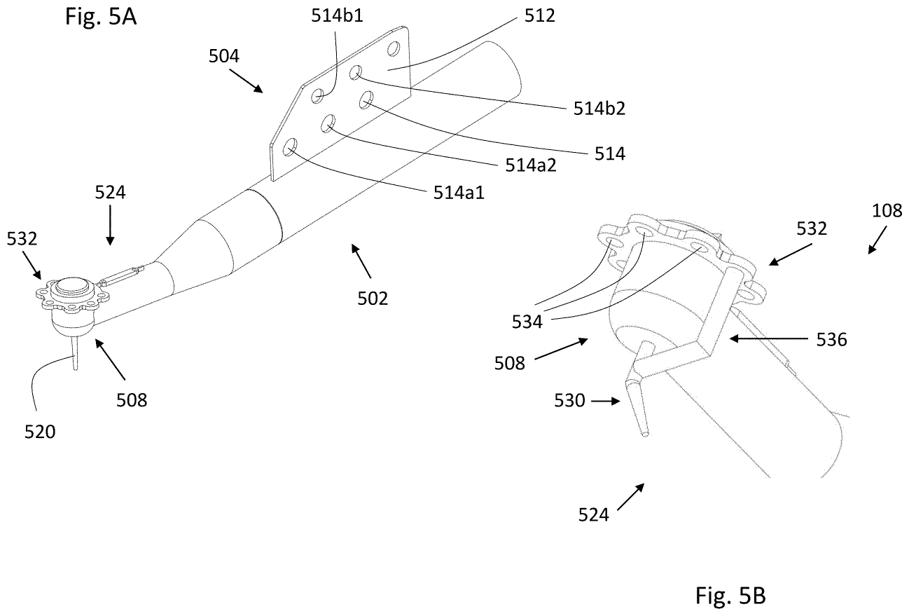

FIG. 4A is a schematic perspective view of CNC machine 104, according to some embodiments. CNC machine 104 includes support infrastructure for mounting thereon of dental turbine 108, as well as turbine maneuvering infrastructure for the controllable movement of dental turbine 108 (or at least a distal portion thereof), as elaborated on below. More specifically, CNC machine 104 includes a CNC base 402 on which the other parts and components of CNC machine 104 are directly or indirectly (via intermediate components) mounted. CNC machine 104 further includes three motors 404: a first motor 404a, a second motor 404b, and a third motor 404c. Each of motors 404 is configured to allow controllable movement (displacement) of dental turbine 108, or at least a turbine collet 508 (indicated in FIGS. 5A and 5B) of dental turbine 108, along an independent trajectory defined by the motor. The three trajectories are said to be “independent” in the sense that the full range of movement afforded thereby cannot be parameterized by a two-dimensional surface (whether curved or not).

As a non-limiting example, according to some embodiments and as depicted in the figures, motors 404 are configured to allow controllable translation of dental turbine 108, or at least turbine collet 508, along each of three orthogonal axes. According to some embodiments, and as depicted in FIG. 4A, motors 404 are configured to allow controllable translation of dental turbine 108 along each of the three axes of a Cartesian coordinate system (so that the trajectories defined by each of motors 404 are linear).

According to some alternative embodiments, not depicted in the figures, the motors may be configured to allow the controllable movement of turbine collet 508 along each of the directions and arcs defined by a spherical coordinate system (r, θ, φ). That is, a first motor may be configured to controllably vary the azimuthal angle φ (characterizing the position of turbine collet 508 relative to the origin), a second motor may be configured to controllably vary the polar angle θ (characterizing the position of turbine collet 508 relative to the origin), and a third motor may be configured to controllably vary the radial distance r (i.e. move turbine collet 508 in the radial direction). According to some other alternative embodiments, not depicted in the figures, the motors may be configured to allow the controllable movement of turbine collet 508 along each of the directions and arcs defined by a cylindrical coordinate system (ρ, φ, z). That is, a first motor may be configured to controllably vary the axial coordinate z, a second motor may be configured to vary the azimuthal angle φ, and a third motor may be configured to controllably vary the axial distance p (i.e. the distance from z-axis).

According to some embodiments, each of motors 404 may be a DC motor, a piezoelectric motor, a stepper motor, a brushless motor, or a hydraulic piston motor.

According to some embodiments, and as depicted in the figures, each of motors 404 is mechanically associated with a respective linear guiding assembly: (i) first motor 404a is mechanically associated with a first linear guiding assembly including a first lead screw 412a, a first linear guide 410a (e.g. a rail), and a first carriage 414a mounted on first linear guide 410a, (ii) second motor 404b is mechanically associated with a second linear guiding assembly including a second lead screw 412b, a second linear guide 410b, and a second carriage 414b mounted on second linear guide 410b, and (iii) third motor 404c is mechanically associated with a third linear guiding assembly including a third lead screw 412c, a third linear guide 410c, and a third carriage 414c mounted on third linear guide 410c.

Each of motors 404 is configured to translate a respective one of carriages 414 along the respective linear guide (from linear guides 410): first motor 404a is configured to translate first carriage 414a along first linear guide 410a, and so on. More precisely, each of motors 404 is configured to rotate a respective one of lead screws 412 (about the axis of the lead screw), thereby causing the respective carriage (from carriages 414) to be moved along the linear guide: first motor 404a is configured to rotate first lead screw 412a, thereby causing first carriage 414a (which is affixed to a nut 416a mounted first lead screw 412a) to be moved along first linear guide 410a, and so on. It is noted that lead screws 412 are orthogonal to one another (as are linear guides 410), so that the translations induced by motors 404 are along orthogonal axes.

According to some embodiments, the first linear guiding assembly may be mounted directly on CNC base 402. The second linear guiding assembly may be mounted on first carriage 414a. Similarly, the third linear guiding assembly may be mounted on second carriage 414b. Thus, when second carriage 414b is translated, so is the third linear guiding assembly, and, in particular, third carriage 414c, and, when first carriage 414a is translated, so are the second linear guiding assembly and the third linear guiding assembly, and, in particular, second carriage 414b and third carriage 414c.

Third carriage 414c is configured to have installed thereon dental turbine 108. According to some embodiments, and as depicted in FIG. 4A, third carriage 414c includes turbine mounting screws 420 on which dental turbine 108 is mountable.

According to some alternative embodiments, not depicted in figures, each of motors 404 is a hydraulic motor including a hydraulic piston (so that each of the linear guiding assemblies does not include a lead screw). Each of the hydraulic pistons is mechanically coupled to, and configured to translate, one of the carriages, respectively.

According to some alternative embodiments, not depicted in figures, each of motors 404 is a piezoelectric motor (so that each of the linear guiding assemblies does not include a lead screw). Each of the piezoelectric motors is configured to transform vibrational motion into linear motion of the respective linear guide and thereby translate the carriage.

According to some embodiments, CNC machine 104 further includes a socket 430 positioned on (or, according to some embodiments, detachably attached to) a distal portion of CNC base 402. Socket 430 forms the socket of ball-and-socket joint 110 and is configured to receive ball 290 of anchoring member 102. A locking screw 432 may be used to affix ball 290 within socket 430 and thereby affix CNC machine 104 to anchoring member 102. According to some embodiments, ball 290 may be received within socket 430 via a side opening 436 in socket 430 with neck element 292 extending through a front opening 438 in socket 430. According to some embodiments, front opening 438 may be characterized by a diameter larger than the width of neck element 292, thereby allowing to change an orientation of CNC machine 104 relative to anchoring member 102 (when locking screw 432 is not fastened), and more specifically, the angle at the zx-plane at which anchoring member 102 is oriented relative to CNC machine 104. In particular, and explained in more detail below, this allows to controllably select the orientation at which CNC machine 104 is affixed to anchoring member 102 and thereby align the drill bit of the dental turbine with long axis of a tooth to be treated.

According to some embodiments, strap 204 may be sufficiently long to allow fastening thereof around the scalp of the subject, thereby allowing to affix anchoring member 102 and dental device to an upper jaw of a subject and to treat maxillary teeth. Alternatively, strap 204 may be removable, such as to allow fastening a strap dedicated about a scalp of a subject.

Referring to FIGS. 3E and 3F, FIG. 3E depicts an anchoring member 102′ affixed to an upper jaw 360 of subject 300, according to some embodiments. Anchoring member 102′ is similar to anchoring member 102 differing therefrom in including a strap 204′ (instead of strap 204), which is configured to be fastened about scalp 320. As shown in FIG. 3E, strap 204′ may include a plurality of strips of material which provide fastening both about scalp top 322 and scalp back 324. FIG. 3F schematically depicts a dental device 100′ affixed to upper jaw 360. Dental device 100′ is similar to dental device 100 but differs therefrom in including anchoring member 102′ in place of anchoring member 102. Also indicated is an arched frame 202′ of anchoring member 102′. Arched frame 202′ may be essentially similar to arched frame 202.

According to some embodiments, CNC machine 104 (in particular motors 404) and dental turbine 108 may be powered by one or more batteries. According to some embodiments, the batteries may be rechargeable and/or removable. According to some embodiments, CNC machine 104, and, optionally dental turbine 108, may be powered via an external power supply. For example, CNC machine 104 may be powered via an electrical cable (not shown), which may be connected to a dental engine or to an electrical wall socket.

CNC machine 104 and dental turbine 108 may be functionally associated with a controller (electronic circuitry; not shown) configured to control the operation thereof (e.g. to direct the motion/displacement of motors 404, to switch on/off dental turbine 108). According to some embodiments, the controller may be included in CNC machine 104, in particular, when CNC machine 104 is powered by battery. According to some alternative embodiments, wherein CNC machine 104 is configured to be powered by an external power supply, the controller may optionally not be included in CNC machine 104, being included instead, for example, in the dental engine.

The controller may be communicatively associated with a processing circuitry (e.g. one or more processors and memory components, e.g. on a desktop computer or on a remote server). The processing circuitry may be configured to send instructions (e.g. a G-code file) to the controller for a shaping (e.g. crown preparation) procedure. According to some embodiments, the controller may further be configured to send data to the processing circuitry regarding, e.g. the positions of carriages 414, and so on. According to some embodiments, wherein the controller is included in CNC machine 104, and in particular, when dental device 100 is configured to be powered by battery, CNC machine 104 may further include a wireless communication unit (e.g. a Bluetooth antenna) configured to communicatively associate the controller with the processing circuitry.

CNC machine 104 may further include limit switches 444 (e.g. optical limit switches) configured to provide carriages 414 with end-stops (i.e. limit the displacements of carriages 414), respectively. More specifically, limit switches 444 include a first limit switch 444a, a second limit switch 444b, and a third limit switch 444c functionally associated (e.g. via the controller) with first carriage 414a and first motor 404a, second carriage 414b and second motor 404b, and third carriage 414c and third motor 404c, respectively.

FIG. 4B presents a schematic (partial) perspective view of dental device 100, according to some embodiments. The view is centered on ball-and-socket mechanism 110. According to some embodiments, and as depicted in FIG. 4B, socket 430 is detachably connected to CNC base 402 via a fastener 452, for example, a screw-based fastener including a nut 456 and a thread-hole 458 (the screw is not shown).

FIG. 4C schematically depicts a CNC bulk 450 (which may be defined as including all of CNC machine 104 apart from socket 430) disconnected (i.e. detached) from socket 430, and, hence, from anchoring member 102 as well. CNC base 402 (which is included in CNC bulk 450) may include a first interlocking component 462 and socket 430 may include a second interlocking component 464. Interlocking components 462 and 464 are configured to interlock. According to some embodiments, and as depicted in FIGS. 4B and 4C, second interlocking component 464 may be a pin and first interlocking component 462 may be a complementary hole (that is, a hole shaped and dimensioned to tightly receive the pin). The inclusion of a second engagement mechanism (in addition to fastener 452) between CNC base 402 and socket 430 that the attachment of CNC bulk 450 to socket 430 is reproducible in the sense that the orientation of CNC bulk 450, and, in particular dental turbine 108, with respect to anchoring member 102 remains unchanged. That is, the orientation prior to the detachment of CNC bulk 450 from socket 430 (when socket 430 is affixed to anchoring member 102) and orientation after the reattachment are the same (as long as none of CNC bulk 450, dental turbine 108, socket 430, and anchoring member 102 are manipulated in the interim in such a manner as to affect the subsequent orientation).

Consequently, when dental device 100 is affixed to a jaw of a subject, CNC bulk 450 may be detached and later reattached in reproducible manner, such that the orientation of CNC bulk 450, and, in particular, dental turbine 108, with respect to a target tooth or teeth remains unchanged. Noting that when CNC bulk 450 is removed the subject may shut their mouth, the above feature advantageously allows for providing rest intervals for the subject during which CNC bulk 450 may be removed and the subject may shut their mouth (though not fully but nevertheless allowing to relax the jaw muscles).

According to some embodiments, not depicted in the figures, wherein the CNC machine is fixedly mountable on the anchoring member via a ball-and-socket joint such that the CNC machine includes the ball and the anchoring member includes the socket, the CNC machine may be detached from, and reattached in a reproducible manner to, a bulk of the anchoring member (which may be defined as including all of the anchoring member apart from socket) in a similar manner to that described above with respect to CNC machine 104 and anchoring member 102. In particular, when detaching the CNC machine, the socket is detached together therewith, such that the socket remains immovably attached (i.e. affixed) to the ball.

It is noted that in FIGS. 4B and 4C rods 230 and 240 are not shown.

While the possibility of detaching and reproducibly reattaching CNC bulk 450 has been demonstrated with respect to an embodiment wherein CNC machine 104 is fixedly mountable on anchoring member 102 via ball-and-socket joint 110, it will be understood that other types connecting elements and/or interlocking components may be used to achieve the same effect. For example, instead of ball-and-socket joint 110, the connecting element may be a three-axis hexapod joint, a six-axis hexapod joint. Similarly, first interlocking component 462 may be a pin (instead of a hole) and second interlocking component 464 may be a hole (instead of a pin), or first interlocking component 462 may include a plurality of holes and/or pins and second interlocking component 464 may include a plurality of complementary pins and/or holes.

The possibility of detaching and reproducibly reattaching a CNC machine (or a bulk thereof) to an anchoring member may be of use in other dental contexts and procedures beyond tooth-shaping procedures, particularly, dental procedures, wherein a subject may be required to keep their mouth open for long durations (e.g. beyond a few minutes), and wherein an orientation and a position of one or more dental instruments must be maintained. The present application addresses such dental contexts and procedures by allowing for detachment and subsequent reproducible reattachment of a CNC machine (which may be dedicated to the dental procedure) or the bulk thereof. The scope of the present application should thus be understood to also cover such dental contexts and procedures.

Typically, after about five minutes, a subject may find it difficult to keep their mouth open and may require rest. The option of detaching a CNC machine (or a bulk thereof), such as to allow reattachment thereof in a reproducible manner, alleviates the necessity of maintaining the orientation the and position of the one or more dental instruments. Relevant procedures may include intra-oral imaging applications, which may require employing a dedicated CNC machine which does not include a dental turbine, or which does not allow for the mounting thereon of a dental turbine. For example, color evaluation of teeth may require obtaining images of the teeth from the same point-of-view of one or more teeth must be taken at different times (e.g. during a period of weeks).

FIG. 5A is a schematic perspective view of dental turbine 108, according to some embodiments. Dental turbine 108 includes an elongated turbine body 502, a wing 504, and turbine collet 508. Wing 504 constitutes a plate 512 projecting from turbine body 502. Plate 512 includes mounting holes 514 (not all of which are numbered). Mounting holes 514 are configured to be fitted on turbine mounting screws 420, thereby mounting dental turbine 108 on third carriage 414c and CNC machine 104. Fasteners (e.g. nuts; not shown) may be used to secure dental turbine 108 to third carriage 414c (by threading the nuts on turbine mounting screws 420). Turbine collet 508 is positioned on, or near, a distal end of turbine body 502 and is configured to receive a drill bit 520.

According to some embodiments, the number of mounting holes 514 may be greater than the number of turbine mounting screws 420. In such embodiments, the spatial arrangement of mounting holes 514 on plate 512 may be such as to allow mounting dental turbine 108 using different mounting holes 514. As a non-limiting example, and as depicted in the figures, turbine mounting screws 420 may include two turbine mounting screws: a first turbine mounting screw 420a and a second turbine mounting screw 420b. Mounting holes 514 may include three pairs of mounting screws, each pair of mounting holes being configured to allow mounting thereby of dental turbine 108 on turbine mounting screws 420a and 420b. For example, dental turbine 108 may be mounted on turbine mounting screws 420a and 420b via mounting holes 514a1 and 514b1, respectively, or, dental turbine 108 may be mounted on turbine mounting screws 420a and 420b via mounting holes 514a2 and 514b2, respectively. The possibility of mounting dental turbine 108 via different pairs of the mounting holes allows to change the distal reach of dental turbine 108 inside the oral cavity. The selection of the pair of mounting holes used may depend, for example, on the position within the oral cavity of the tooth to be treated, as well as the dimensions of the oral cavity, which may vary considerably between subjects, e.g. between a child and an adult.

FIG. 5B is a schematic perspective view of a distal portion 524 of dental turbine 108, according to some embodiments. Turbine collet 508 is shown with a tactile probe 530 mounted thereon. As elaborated on below in the Methods Subsection, tactile probe 530 may be used to obtain data indicative of a structure of a target tooth, to be treated, in preparation for the treatment. According to some embodiments, dental turbine 108 may further include an orientation selection component 532 mounted on the top of turbine collet 508. More specifically, orientation selection component 532 may include mounting holes 534, which may be circularly arranged around the circumference of turbine collet 508. A probe arm 536 may be used to couple tactile probe 530 to different mounting holes and thereby change the orientation of tactile probe 530. The choice of orientation may depend on the target tooth to be probed, in particular, the orientation of a surface thereof. According to some embodiments, orientation selection component 532 may be rotated, in particular, when the dental turbine 108 is positioned within the oral cavity of subject.

According to some embodiments, dental turbine 108 may include thereon three visual indicators (not shown). The visual indicators may be positioned on distal portion 524 of turbine body 502, for example, on turbine collet 508, such as to allow using an imager to 3D scan or capture photos of the visual indicators together with a surface of a tooth which is to be treated, when dental device 100 is properly affixed to a jaw of a subject, as elaborated on below and in the Methods Subsection. The visual indicators are positioned relative to one another such as to define a fixed triangle (i.e. the visual indicators are positioned at the corners of the triangle, respectively). The coordinates of each of the visual indicators relative to dental turbine 108 and therefore relative to CNC machine 104 are known. When dental device 100 is properly affixed to a jaw of subject, the visual indicators allow obtaining the position and orientation of drill bit 520 inside the oral cavity of the subject, and, in particular, the distance of drill bit 520 from a target tooth (which is to be treated) and the orientation of drill bit 520 relative to the target tooth.

According to some embodiments, the orientation markers may be provided by geometrical features of probe arm 536 (of tactile probe 530).

According to some embodiments, dental device 100 may further include an imager, such as a 3D scanner or a camera, and optionally one or more mirrors, positioned thereon such as to allow using the imager to 3D scan or capture photos of the visual indicators together with a surface of a tooth which is to be treated when dental device 100 is properly affixed to a jaw of a subject.

According to some embodiments, the imager may be configured to send data of an imaged tooth (e.g. an STL file when the imager is an optical 3D scanner), obtained by the imager, to a processing circuitry. The processing circuitry may have software installed thereon to analyze the data and produce instructions (e.g. in the form of a G-code file) for shaping the imaged tooth.

As used herein, according to some embodiments, the term “imager” should be understood covers not only optical imagers, but also other types of sensors, such as, for example, various types of proximity sensors, tactile probes (e.g. a contact 3D scanner), and so on.

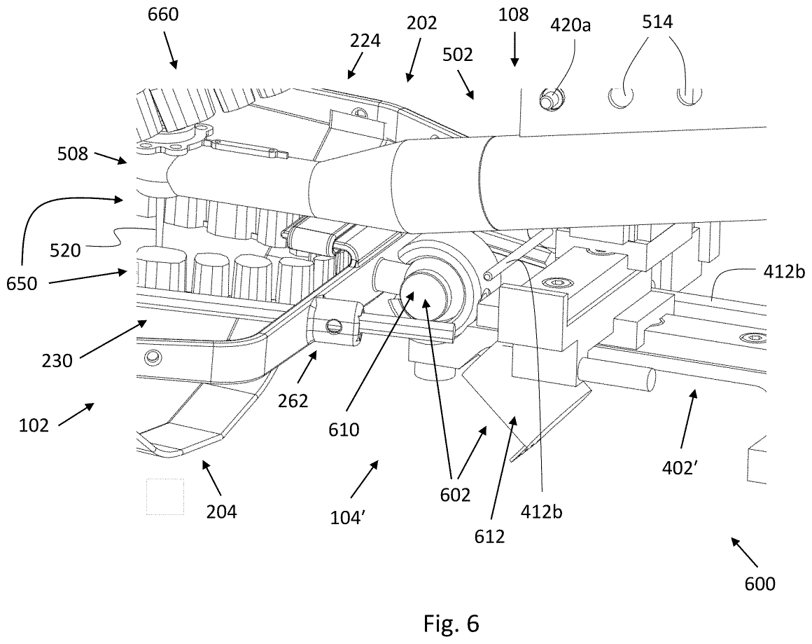

FIG. 6 presents a schematic (partial) perspective view of a dental device 600, according to some embodiments. Dental device 600 includes anchoring member 102, a CNC machine 104′, and dental turbine 108. CNC machine 104′ is similar to CNC machine 104 but differs therefrom at least in including a non-manual locking mechanism 602 configured to secure (affix) CNC machine 104′ to anchoring member 102 (whereas CNC machine 104 is manually secured to anchoring member 102, e.g. by manually fastening locking screw 432 of ball-and-socket joint 110). According to some embodiments, CNC machine 104′ is configured to be affixed to anchoring member 102 via a ball-and-socket joint 610, such as, or similar to, ball-and-socket-joint 110 of dental device 100, with the difference that ball-and-socket joint 610 is mechanically associated with locking mechanism 602 and is configured to be locked/unlocked thereby.

More specifically, according to some embodiments, locking mechanism 602 includes a locking motor 612 mechanically associated with a locking screw (hidden from view in FIG. 6) of ball-and-socket-joint 610 and configured to fasten/unfasten the locking screw, thereby affixing CNC machine 104 to anchoring member 102.

In FIG. 6, dental device 600 is shown affixed to (some of) mandibular teeth 650. Also indicated are maxillary teeth 660.

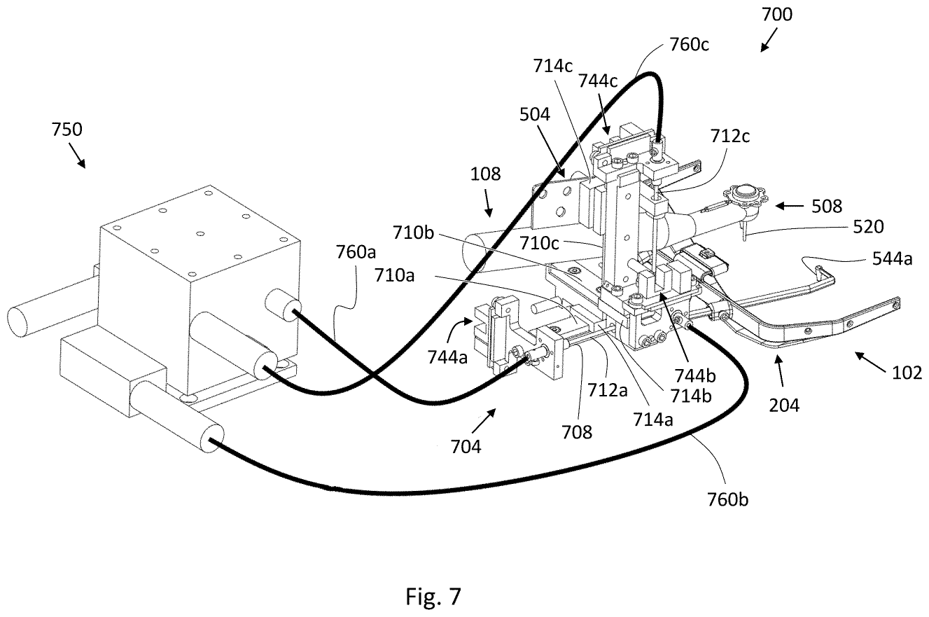

Referring to FIG. 7, according to an aspect of some embodiments, there is provided a dental device 700 for shaping teeth of a subject, which is configured to be affixed to, and supported on, a jaw of the subject. FIG. 7 presents a schematic perspective view of dental device 700, mechanical actuation unit 750, and a plurality of mechanical actuation cables 760, according to some embodiments. Dental device 700 is similar to dental device 100 but differs therefrom in including a CNC machine 704 configured for remote mechanical actuation (by mechanical actuation unit 750 via mechanical actuation cables 760, as described below).

According to some embodiments, in addition to CNC machine 704, dental device 700 further includes anchoring member 102 and dental turbine 108. CNC machine 704 may be configured to be affixed to anchoring member 102, in the same manner as described above (in the description of dental device 100) with respect to CNC machine 104 and anchoring member 102 or with respect to CNC machine 104′ and anchoring member 102. Similarly, CNC machine 704 may be configured to have dental turbine 108 installed thereon, in the same manner as described above (in the description of dental device 100) with respect to CNC machine 104 and dental turbine 108.

According to some embodiments, CNC machine 704 includes a CNC base 708 and a turbine maneuvering infrastructure mounted on CNC base 708. As a non-limiting example, in FIG. 7, the turbine maneuvering infrastructure includes three linear guiding assemblies, but it will be understood that alternative turbine maneuvering infrastructure (not depicted in FIG. 7) are possible. For example, the turbine maneuvering infrastructure may be configured to move turbine collet 508 along each of the directions and arcs defined by a spherical coordinate system or a cylindrical coordinate system.

Each linear guiding assembly includes a linear guide and a carriage mounted and thereon configured to be translated there along. In FIG. 7, each of the three linear guiding assemblies includes a lead screw, a linear guide, and a carriage mounted on the linear guide and configured for motion there along. More specifically, CNC machine 704 includes three lead screws 712, three linear guide 710, and three carriages 714. Lead screws 712 include a first lead screw 712a, a second lead screw 712b (only a tip thereof is visible in FIG. 7), and a third lead screw 712c. Linear guide 710 include a first linear guide 710a, a second linear guide 710b, and a third linear guide 710c. Carriages 714 include a first carriage 714a mounted on first linear guide 710a and mechanically associated with first lead screw 712a, a second carriage 710b mounted on second linear guide 710b and mechanically associated with second lead screw 712b, and a third carriage 714c mounted on third linear guide 710c and mechanically associated with third lead screw 712c.

According to some embodiments, third linear guide 710c, third lead screw 712c, and thereby third carriage 714c may be mounted on second carriage 714b. Second linear guide 710b, second lead screw 712b, and second carriage 714b may be mounted on first carriage 714a. First linear guide 710a, first lead screw 712a, and first carriage 714a may be mounted on CNC base 708. Dental turbine 108 is mountable on third carriage 714c (third carriage 714c may include turbine mounting screws—hidden from view in FIG. 7—similar to turbine mounting screws 420). According to some embodiments, first lead screw 712a may extend along the x-axis, being thereby configured to allow translating first carriage 714a (and thereby dental turbine 108) along the x-axis. Second lead screw 712b may extend along the y-axis, being thereby configured to allow translating second carriage 714b (and thereby dental turbine 108) along the y-axis. Third lead screw 712c may extend along the z-axis, being thereby configured to allow translating third carriage 714c (and thereby dental turbine 108) along the z-axis.

Mechanical actuation unit 750 houses a plurality of motors (not shown). Each of mechanical actuation cables 760 may be mechanically coupled, on a first end thereof, to a respective one of the motors (housed in mechanical actuation unit 750) and on a second end thereof, to a respective one of the linear guiding assemblies. According to some embodiments, and as depicted in FIG. 7, mechanical actuation cables 760 include a first mechanical actuation cable 760a mechanically coupled to first lead screw 712a, a second mechanical actuation cable 760b mechanically coupled to second lead screw 712b, and a third mechanical actuation cable 760c mechanically coupled to third lead screw 712c. It should be noted that mechanical actuation cables 760 do not provide support to dental device 700 and are further configured not to exert any forces on CNC machine 704 beyond the forces exerted for maneuvering dental turbine 108, so that no load is applied thereby on the teeth of a subject to which dental device 700 is affixed.

According to some embodiments, mechanical actuation cables 760 may be torque-transmitting flexible shafts (e.g. flexible rotary driveshafts). Each of the motors may be configured to apply a torque to one of mechanical actuation cables 760, respectively, which in turn transmits resultant rotary motion to one of lead screws 712, respectively (and thereby induces translation of the respective carriage).

According to some embodiments, not depicted in the figures, mechanical actuation cables 760 may be pull-force transmitting flexible shafts. Each of the mechanical actuation cables is mechanically coupled to one of the carriages, respectively (being thereby configured to translate the carriage).

Also indicated are limit switches 744: a first limit switch 744a, a second limit switch 744b, and a third limit switch 744c functionally associated with first carriage 714a, second carriage 714b, and third carriage 714c, respectively.

According to some alternative embodiments, not depicted in FIG. 7, each of the linear guiding assemblies includes a hydraulic piston (instead of a lead screw), which is mechanically coupled to, and configured to translate, one of the carriages. Further, each of the mechanical actuation cables may be a (miniature) hydraulic flexible tube. Each of the hydraulic flexible tubes is fluidly coupled on one end thereof to a hydraulic motor (in the mechanical actuation unit), and, on the other end thereof, to one of the hydraulic pistons, respectively.

According to some embodiments, not depicted in FIG. 7, CNC machine 704 may be configured to be secured to anchoring member 102 via a remotely actuated non-manual locking mechanism. The locking mechanism may be similar to locking mechanism 602 of dental device 600 in the sense of being configured to lock and unlock a ball-and-socket joint (utilized used to controllably affix CNC machine 704 to anchoring member 102; the ball-and-socket joint is hidden from view in FIG. 7) but differs therefrom in that CNC machine 704 does not include a motor, such as locking motor 612. Instead, mechanical actuation 750 may include an additional motor dedicated to this end. More specifically, mechanical actuation unit 750 may further be configured to remotely activate the locking mechanism via an additional mechanical actuation cable mechanically coupled, on one end thereof, to the additional (dedicated) motor in mechanical actuation unit 750, and, on a second end thereof, to the affixing mechanism.

According to some embodiments, base 708 is configured to be detached from, and reproducibly reattached to, a connecting element (not shown), such as ball-and-socket joint 110, which is utilized to fixedly mount CNC machine 704 on anchoring member 102, essentially as described hereinabove with respect to CNC machine 104 and anchoring member 102 in the description of dental device 100.

According to some embodiments, mechanical actuation unit 750 may include a controller (not shown) configured to control the operation of the motors in mechanical actuation unit, and, thereby, the maneuvering of carriages 714 and of dental turbine 108. An additional cable (an electrical cable; not shown), may be used to relay instructions from the controller to dental turbine 108, e.g. to switch on/off dental turbine 108. According to some embodiments, dental turbine 108 may include additional functions/capabilities, the additional functions/capabilities may be controlled by the controller. For example, according to some embodiments, dental turbine 108 may include a camera and/or a 3D scanner, whose operation is controlled by the controller.

According to some embodiments, mechanical actuation unit 750 may be installable on a dentist chair (not shown). According to some embodiments, mechanical actuation unit 750 may be configured to be powered via a dental engine or may form part of the dental engine. Additionally or alternatively, mechanical actuation unit 750 may include a power cable (not shown) configured to be connected to an electrical wall socket. According some embodiments, mechanical actuation unit 750 may be powered by battery (e.g. a rechargeable battery).

According to an aspect of some embodiments, not depicted in the figures, there is provided a dental device which similar to both dental device 700 and dental device 100′ in the following sense: The dental device is similar to dental device 700 in being configured to be remotely mechanically actuated by a mechanical actuation unit, such as mechanical actuation unit 750 (and in not including motors such as motors 404). The dental device is similar to dental device 100′ in being configured to be affixed to an upper jaw of a subject. In particular, the dental device includes a strap, such as strap 204′ of dental device 100′, which is configured to be fastened about a scalp of a subject.

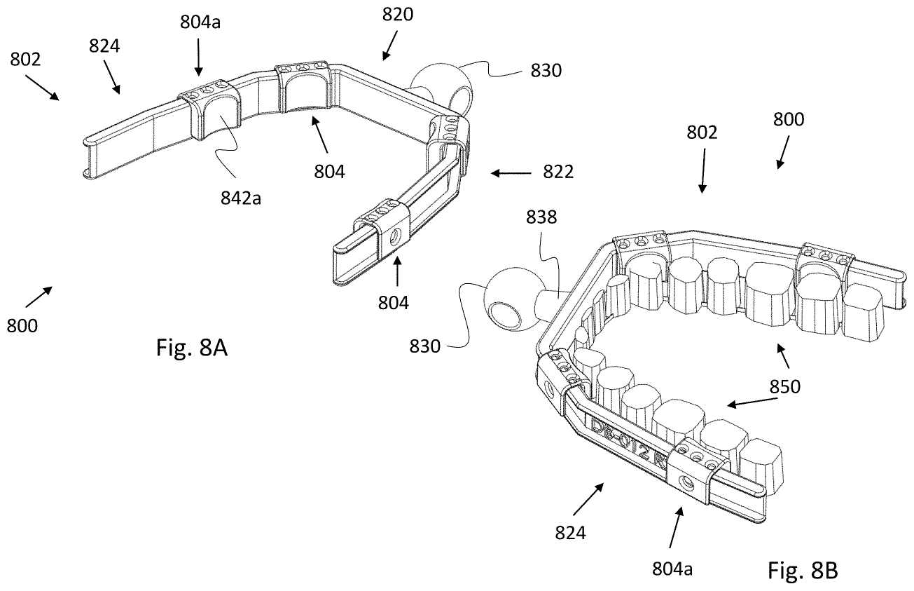

FIG. 8A schematically depict an anchoring member 800, according to some embodiments. Anchoring member 800 is configured to be affixed to a jaw of a subject by securing of anchoring member 800 to one or more teeth of the subject. Anchoring member 800 provides an alternative fixation mechanism to a jaw of a subject to that of anchoring member 102. In particular, and as elaborated on below, anchoring member 800 is configured to have a CNC machine, such as CNC machine 104, CNC machine 104′, CNC machine 704, and CNC machines similar thereto, mounted on and affixed to anchoring member 800.

FIG. 8B schematically depicts anchoring member 800 secured to mandibular teeth 850 of a subject, according to some embodiments.

Anchoring member 800 includes an arched frame 802 and a plurality of tooth-engaging components 804 (as a non-limiting example, four in FIGS. 8A and 8B) mounted on arched frame 802. Arched frame 802 may include a base 820, a first arm 822, and a second arm 824, with base 820 being positioned between first arm 822 and second arm 824. A ball 830 (from a ball-and-socket joint configured to allow controllably affixing anchoring member 800 to a CNC machine, such as, for example, CNC machine 104) may be mounted on the proximal side of base 820, e.g. via a neck element 838. According to some embodiments, tooth-engaging components 804 include at least three tooth-engaging components.

Each of tooth-engaging components 804 may be configured such as to allow encompassing a facial surface of at least one tooth. That is, the inner surfaces of each tooth-engaging components 804 may be shaped and dimensioned such as to allow encompassing a facial surface of at least one tooth, respectively. For example, an inner surface 842a of a second arm tooth-engaging component 804a (from tooth-engaging components 804), which is positioned on second arm 824, may be configured to encompass a buccal surface of a left mandibular molar.

To affix anchoring member 800 to the teeth, (removable) dental cement may be used to glue the inner surface of each of tooth-engaging components 804 to the respective facial surfaces of the corresponding teeth.

While in FIG. 8B, anchoring member 800 is shown secured to mandibular teeth of a subject (and so to a lower jaw thereof), it is to be understood that, according to some embodiments, anchoring member 800 may be affixed instead to an upper jaw of a subject.

In particular, different embodiments of anchoring member 800 may differ in shape and dimensions such as to allow affixing to different jaws of different subjects.

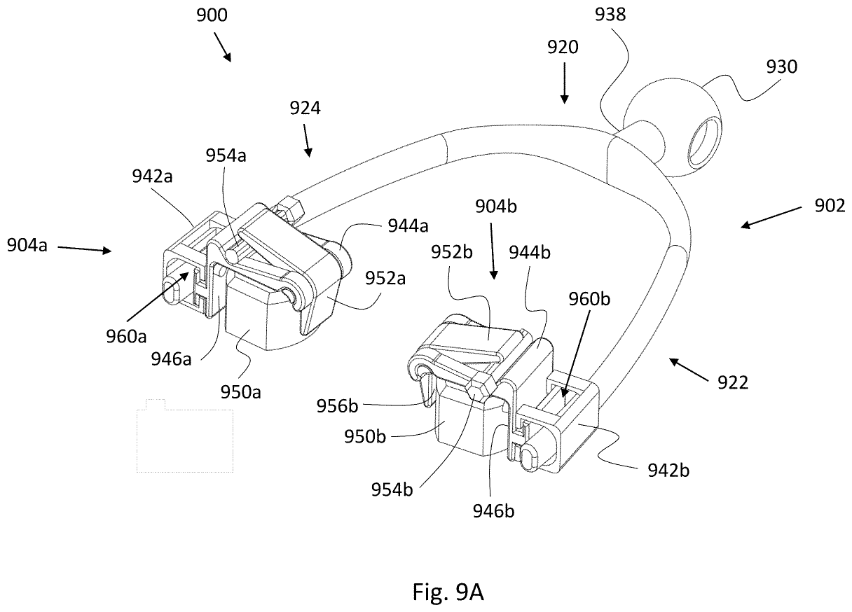

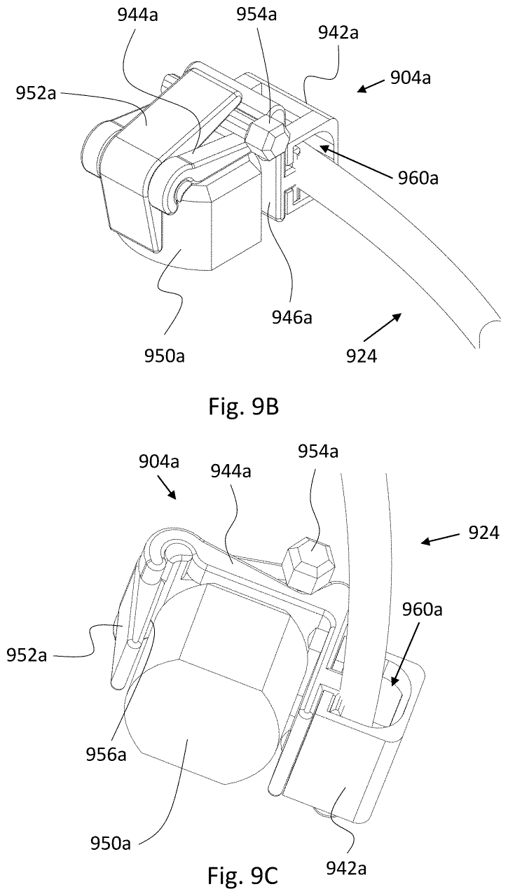

FIGS. 9A-9C schematically depict an anchoring member 900, according to some embodiments. Anchoring member 900 is configured to be affixed to a jaw of a subject by securing of anchoring member 900 to one or more teeth of the subject. Anchoring member 900 provides an alternative fixation mechanism to those of anchoring member 102 and anchoring member 800. In particular, and as elaborated on below, anchoring member 900 is configured to have a CNC machine, such as CNC machine 104, CNC machine 104′, CNC machine 704, and CNC machines similar thereto, mounted on and affixed to anchoring member 900.

Anchoring member 900 includes an arched frame 902 and a plurality of tooth-engaging components 904 (two tooth-engaging components are depicted in FIG. 9A, but it will be understood that tooth-engaging components 904 may include more than two tooth-engaging components, for example, three tooth-engaging components). Tooth-engaging components are mounted on arched frame 902. Arched frame 902 may include a base 920, a first arm 922, and a second arm 924, with base 920 being positioned between first arm 922 and second arm 924. A ball 930 (from a ball-and-socket joint configured to allow controllably affixing anchoring member 900 to a CNC machine, such as, for example, CNC machine 104) may be mounted on the proximal side of base 920, e.g. via a neck element 938.

Each of tooth-engaging components 904 may include a carriage whereby the tooth-engaging component is mounted on arched frame 902. For example, a second arm tooth-engaging component 904a includes a carriage 942a whereby second arm tooth-engaging component 904a is mounted on second arm 924. Carriage 942a may have mounted thereon a cradle element 944a including a first contact surface 946a which is configured to engage a facial surface of a target tooth (to which the tooth-engaging component is to be secured), for example, a molar 950a. A lever 952a may be mechanically associated to cradle element 944a via a twist lock 954a (screw). More specifically, lever 952a may include a second contact surface 956a configured to engage a lingual surface of the target tooth. When lever 952a is pressed, twist lock 954a locks lever 952a over the target tooth, such that the tooth is pressed between first contact surface 946a and second contact surface 956a, thereby securing second arm tooth-engaging component 904a to the target tooth.

Similarly, a first arm tooth-engaging component 904b (from tooth-engaging components 904) may include a carriage 942b, a cradle element 944b, a lever 952b, and a twist lock 954b, and is shown in FIG. 9A secured to a molar 950b. Also indicated are a first contact surface 946b of cradle element 944b, a second contact surface 956b of lever 952b, and compartment 960b configured to be filled with dental cement.

According to some embodiments, each of tooth engaging-component 904 is shiftable along arched frame 902 such as to allow each of tooth engaging-components 904 to be optimally positioned relative to a target tooth, and, optionally, to allow each of tooth-engaging components 904 to engage different teeth.

According to some embodiments, to ensure that arched frame 902 does not budge with respect to tooth-engaging components 904, each of tooth-engaging components 904 may be affixed to arched frame 902 using dental cement. More specifically, each of the carriages may include a cavity wherethrough arched frame 902 passes and which is configured for being filled with dental cement, thereby affixing the carriage (and the tooth-engaging component) to arched frame 902. For example, carriage 942a includes a compartment 960a configured to be filled with dental cement and thereby affix second arm tooth-engaging component 904a to second arm 924.

According to some embodiments, anchoring member 900 may be affixed not only to lower jaws but also to upper jaws. In particular, different embodiments of anchoring member 900 may differ in shape and dimensions such as to allow affixing to different jaws of different subjects.

Methods

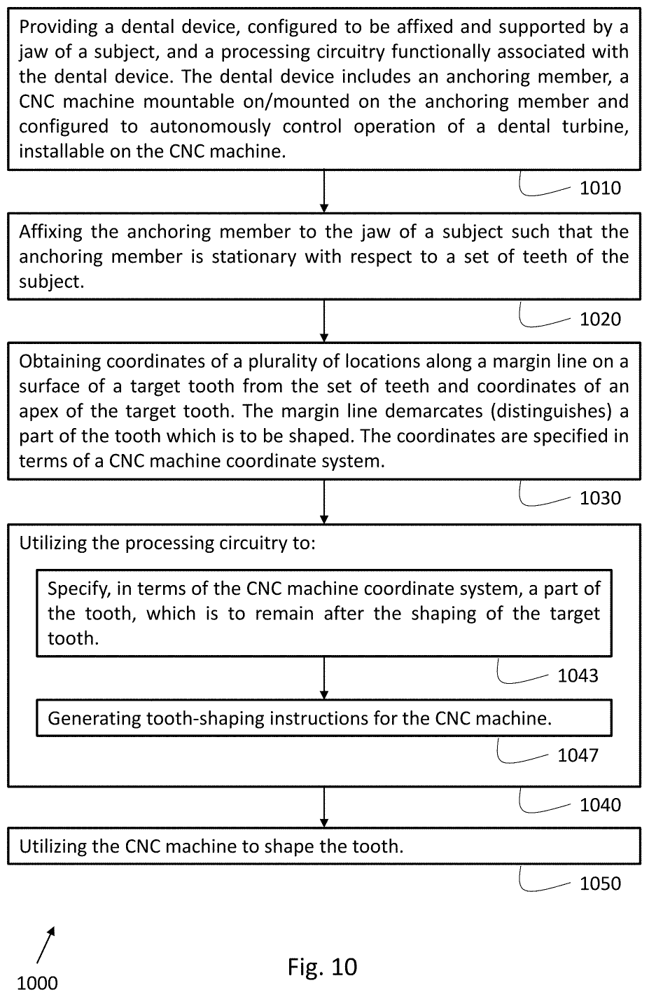

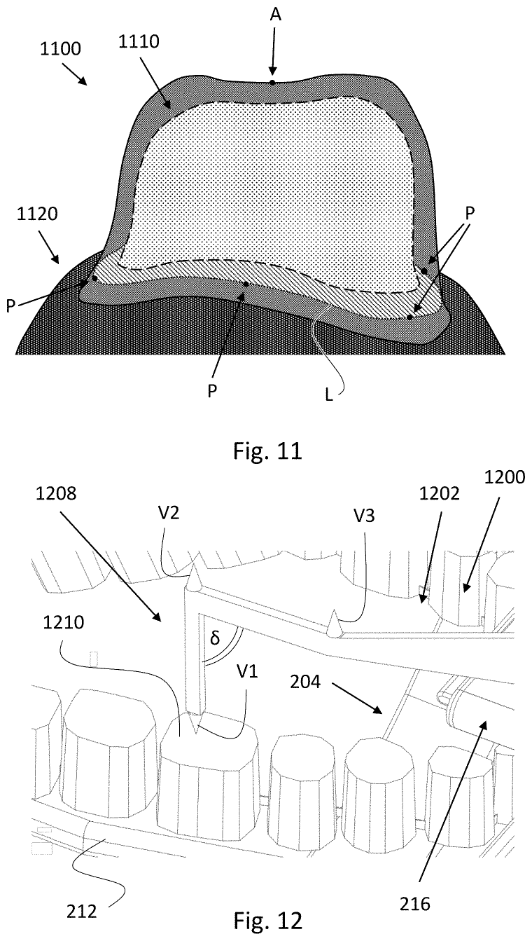

According to an aspect of some embodiments, there is provided a method for shaping teeth of a subject. FIG. 10 is a flowchart of such a method, a method 1000, according to some embodiments. Method 1000 may be implemented using any of dental devices 100, 100′, 600, 700, the dental device including anchoring member 800, the dental device including anchoring member 900, other previously described dental devices that do not appear in the figures, and dental devices similar thereto. According to some embodiments, method 1000 includes:
A stage 1010 of providing a dental device and a processing circuitry functionally associated with the dental device. The dental device includes an anchoring member, a computerized numerical control (CNC) machine, and a dental turbine. The anchoring member is configured to be affixed to a jaw of a subject, such that the dental device is supported by the jaw. The CNC machine is configured to control operation of a dental turbine, installable on the CNC machine.
A stage 1020 of removably affixing the dental device to the jaw of a subject such that the dental device remains stationary with respect to a set of teeth of a subject.
A stage 1030 of obtaining coordinates of a plurality of locations along a margin line on a surface of a target tooth from the set of teeth, as well as coordinates of an apex of the target tooth (indicated in FIG. 11). The margin line serves to indicate a part of the target tooth which is to be shaped. The coordinates are specified in terms of a CNC machine coordinate system. That is, a coordinate system which is fixed with respect to the CNC machine.
A stage 1040 including:
   A substage 1043, wherein, based on the coordinates obtained in stage 1030, the processing circuitry is utilized to specify, in terms of the CNC machine coordinate system, a part of the tooth, which is to remain after the shaping of the tooth.
   A substage 1047 of generating tooth-shaping instructions for the CNC machine, based on the data generated in substage 1043
A stage 1050 of utilizing the CNC machine to shape the target tooth, based on the tooth-shaping instructions generated in substage 1047.

Referring also to FIG. 11, FIG. 11 schematically depicts a target tooth 1100, which is to be shaped using method 1000. Indicated are a tooth part 1110 of target tooth 1100, which is to remain after the shaping, and gingiva surrounding the root of target tooth 1120. Also indicated are a margin line L (i.e. the margin line from stage 1030), at least some of a plurality of locations P on margin line L (i.e. the plurality of locations from stage 1030), and an apex A of target tooth 1100 (i.e. the apex from stage 1030).

Stage 1020 may include a substage 1023 wherein the anchoring member is affixed to the jaw of the subject and a substage 1027 wherein the CNC machine is affixed to the anchoring member. According to some embodiments, wherein the method is performed using a dental device, such as, for example, dental devices 100, 100′, 600, and 700, stage 1020 may further include a substage 1025, performed prior to substage 1027, wherein the CNC machine is oriented such that the z-axis of the CNC machine coordinate system is set in parallel (or otherwise directed according to the dentist's discretion) to the long axis of the target tooth. According to some embodiments, substage 1025 ensures that the drill bit of the dental turbine will extend in parallel to the long axis of the target tooth and that the reciprocating motion of the drill bit be parallel to the long axis of the target tooth, since the orientation of the drill bit is set to be parallel to the z-axis of the CNC machine.

According to some embodiments of method 1000, wherein method 1000 is employed in preparation of installation of a dental bridge, in substage 1025, the CNC machine may be oriented in an optimal manner (as per the judgement of the dentist) relative to the long axes of a plurality of target teeth (on which the dental bridge is to be installed).

According to some embodiments, during stage 1020 the dental turbine (e.g. dental turbine 108) need not yet be affixed to CNC machine (e.g. CNC machine 104), as the CNC machine and dental turbine are configured such that the dental turbine is installable at a fixed (and reproducible) orientation relative to the CNC machine coordinate system.

Stage 1030 may be implemented using an imager. According to some embodiments, the imager may include a 3D scanner, and/or a camera(s) (and, optionally, one or more mirrors), and/or a tactile probe. According to some embodiments, the imager may form part of the dental device or be installed thereon. According to some other embodiments, the imager is separate from the dental device. According to some such embodiments, the imager may be operated manually.

According to some embodiments, wherein the imager is 3D scanner, stage 1030 may include 3D-scanning at least a surface of the target tooth together with three visual indicators (identifiable locations), e.g. on the dental turbine, such that (i) the three visual indicators define a triangle with corners that are fixed with respect to one another, and (ii) CNC machine coordinates of each of the locations are known. Utilizing 3D-scan analysis software (e.g. stored in the memory of the processing circuitry or a remote memory associated with the processing circuitry), the processing circuitry may be used to extract the CNC machine coordinates of the plurality of locations on the margin line and the CNC machine coordinates of the apex. More specifically, 3D-scan analysis software may be configured to identify/construct the margin line and to identify suitable locations on the margin line, and thereby define the plurality of locations.

According to some embodiments, the plurality of locations along the margin line may include at least six locations.

Referring also to FIG. 12, according to some embodiments, the dental turbine does not include the visual indicators. Instead an indicator member may be used, such as an indicator member 1200 depicted in FIG. 12. The indicator member may be mountable on the CNC machine at a fixed and known orientation relative thereto (e.g. indicator member 1200 may be mounted CNC machine 104 via turbine mounting screws 420). The indicator member may be shaped and dimensioned such as ensure that comparatively little of the oral cavity and the teeth are hidden by the indicator member as the target tooth and the indicator member are imaged together. Thus, for example, the indicator member may include an elongated arm, such as an arm 1202 of indicator member 1200. A distal portion of the arm (e.g. a distal portion 1208 of arm 1202), which is inserted into the oral cavity during the imaging, may be thin and may be set at an angle δ with respect to the rest of the rod or may be curved. The distal portion may include at least three visual indicators (such as visual indicators V1, V2, and V3 on distal portion 1208) which define there between a fixed triangle. The locations on the rod of the visual indicators are known (with respect to the rod) and may therefore be expressed in terms of the CNC machine coordinate system. The thinness of the distal portion to ensure that comparatively little of the oral cavity and the target tooth (e.g. a target right mandibular molar 1210) are hidden by the distal portion during the imaging. Also indicated in FIG. 12 are strap 204 and central tooth-engaging component 216.

According to some embodiments, wherein the imager includes a camera, and optionally one or more mirrors, method 1000 may further includes a stage 1015, performed prior to stage 1020, wherein the plurality of locations along the margin line and the apex are marked (e.g. manually marked by the dental surgeon). As a non-limiting example, according to some embodiments, the plurality of locations may be painted by a surgical pencil or a dermatology pencil. In such embodiments, stage 1030 may further include a substage 1033 of using the camera to obtain a plurality of photos of the tooth from various angles, which capture the marks together with three visual indicators on the dental turbine or on the indicator member, as described above. Utilizing image processing software, in a substage 1037, the processing circuitry may be used to extract the CNC machine coordinates of the plurality of locations on the margin line and the CNC machine coordinates of the apex.

According to some embodiments, wherein the imager includes a tactile probe (such as tactile probe 530 of FIG. 5B), method 1000 may further include a stage 1015, performed prior to stage 1020, wherein a surface of the target tooth is scanned, using the tactile probe, in order to obtain data indicative of a structure of the surface. The processing circuitry may then be utilized to extract the CNC machine coordinates of the plurality of locations on the margin line and the CNC machine coordinates of the apex from the data obtained from the tactile probe. It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

It is noted that in the case of teeth preparation for the installation of a dental bridge, method 1000 allows to process the teeth such that the processed teeth are oriented in the same direction, thereby enabling precise fitting of the dental bridge on the processed teeth. This acts to prevent, or at least reduce, appearance of stress forces acting on the dental bridge, which may lead to problems and complications.

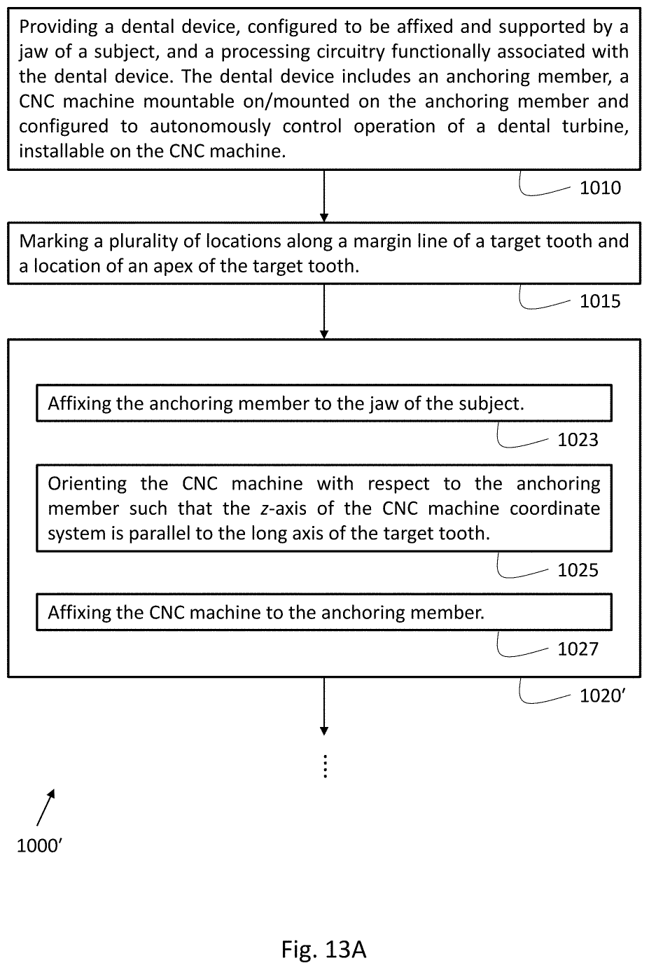

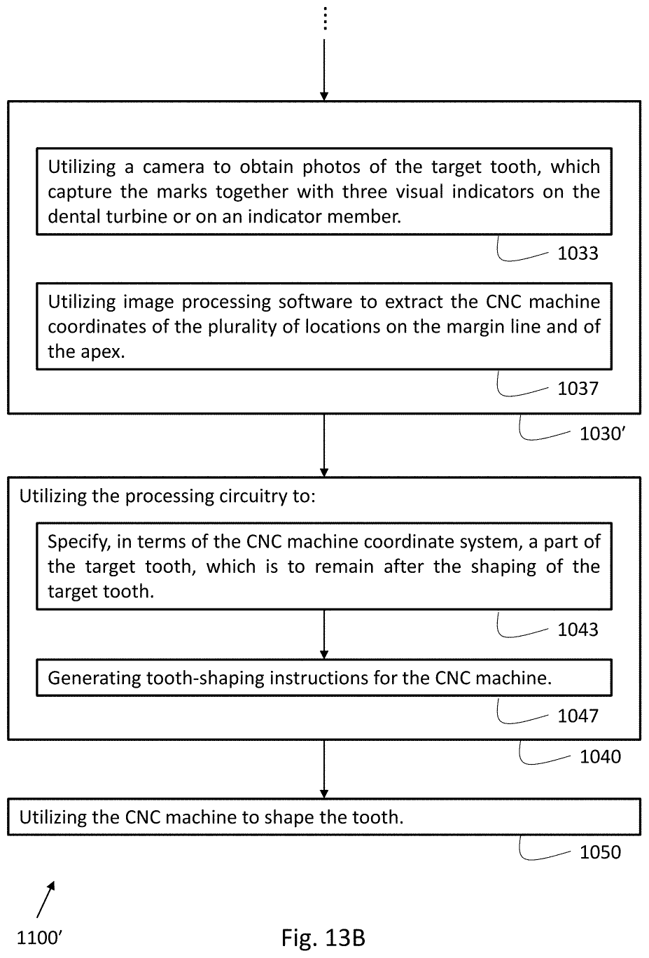

FIGS. 13A and 13B present a flowchart of a method 1000′ which is a specific embodiment of method 1000. In particular, method 1000′ includes stages 1020′ and 1030′, which are specific embodiments of stages 1020 and 1030, respectively.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1.-88. (canceled)

89. A mountable dental device for shaping a tooth of a subject, the device comprising:
an anchoring member configured to be removably affixed to a jaw of a subject by securing thereof to one or more teeth of the subject; and
a computerized numerical control (CNC) machine fixedly mounted or fixedly mountable on the anchoring member, the CNC machine being configured to have installed thereon and maneuver a dental turbine;
wherein, when the anchoring member is affixed to the jaw, the device is supported by the subject;
wherein the anchoring member is adjustable such as to allow the affixing thereof to jaws of different subjects; and
wherein the CNC machine is configured to control operation of the dental turbine in at least one dental tooth-shaping procedure on at least one tooth of the subject.

90. The device of claim 89, wherein the at least one dental tooth-shaping procedure comprises grinding of a tooth in preparation for installing a dental crown on the tooth.

91. The device of claim 90, wherein the at least one dental tooth-shaping procedure further comprises grinding at least two teeth in preparation for installing a dental bridge on the at least two teeth.

92. The device of claim 89, wherein the at least one tooth comprises a mandibular tooth and wherein the device is configured to be affixed to a lower jaw of the subject, and/or wherein the at least one tooth comprises a maxillary tooth and wherein the device is configured to be affixed to an upper jaw of the subject.

93. The device of claim 89, further comprising the dental turbine.

94. The device of claim 89, wherein the CNC machine comprises turbine maneuvering infrastructure configured to allow controllably moving at least a distal portion of the dental turbine along each of three independent directions and/or arcs.

95. The device of claim 94, wherein the turbine maneuvering infrastructure is configured to allow moving the distal portion of the dental turbine at least about 15 mm along each of the three independent directions and/or arcs.

96. The device of claim 94, wherein the turbine maneuvering infrastructure is configured to allow controllably translating the distal portion of dental turbine along each of three orthogonal axes of a Cartesian coordinate system.

97. The device of claim 96, wherein the turbine maneuvering infrastructure comprises three linear guiding assemblies configured to allow controllably translating the distal portion of the dental turbine along each of the three orthogonal axes, respectively.

98. The device of claim 97, wherein each of the linear guiding assemblies comprises a linear guide and a carriage mounted on the linear guide and configured to be translated there along.

99. The device of claim 98, wherein each of the linear guiding assemblies further comprises a lead screw and a nut mounted thereon and connected to the carriage of the linear guiding assembly.

100. The device of claim 97, wherein the linear guiding assemblies comprise a first linear guiding assembly, a second linear guiding assembly, and a third linear guiding assembly, wherein the dental turbine is installable on the third linear guiding assembly and is configured to be translated thereby, wherein the third linear guiding assembly is mounted on the second linear guiding assembly and is configured to be translated thereby, and wherein the second linear guiding assembly is mounted on the first linear guiding assembly and is configured to be translated thereby.

101. The device of claim 89, wherein the CNC machine further comprises an electric-based actuator, a pneumatic-based actuator, or a flexible driveshaft-based actuator configured to affix the mounting of the CNC machine on the anchoring member, such as to prevent load from being applied onto the teeth of the subject during the affixing of CNC machine to the anchoring member.

102. The device of claim 89, wherein the CNC machine is fixedly mountable on the anchoring member via a ball-and-socket joint, a three-axis hexapod joint, or a six-axis hexapod joint.

103. The device of claim 94, wherein the CNC machine is fixedly mountable or fixedly mounted on the anchoring member via a connecting element, and wherein a CNC bulk of the CNC machine, the CNC bulk comprising the turbine maneuvering infrastructure, is detachable from the connecting element, such as to allow reattaching the CNC bulk to the connecting element in a reproducible manner, wherein an orientation of the dental turbine relative to the anchoring member remains unchanged as compared to prior to the detachment; or
wherein the CNC machine is fixedly mountable or fixedly mounted on the anchoring member via a connecting element, and wherein the connecting element, together with the CNC bulk, are detachable from an anchoring member bulk of the anchoring member, the anchoring member bulk comprising the arched frame, the strap, and the tooth-engaging components, the detachment being such that (i) the CNC bulk remains affixed to the connecting element and (ii) the connecting element together with the CNC bulk are reattachable to the anchoring member bulk in a reproducible manner, wherein an orientation of the dental turbine relative to the anchoring member remains unchanged as compared to prior to the detachment.

104. The device of claim 103, wherein the CNC bulk is attachable to the connecting element via a CNC bulk fastener, and wherein the CNC bulk comprises a first interlocking component and the connecting element comprises a second interlocking component configured to interlock with the first interlocking component, such as to allow reattachment of the CNC bulk to the connecting element in a reproducible manner; or
wherein the anchoring member bulk is attachable to the connecting element via a anchoring member bulk fastener, and wherein the anchoring member bulk comprises a first interlocking component and the connecting element comprises a second interlocking component configured to interlock with the first interlocking component, such as to allow reattachment of the anchoring member bulk to the connecting element in a reproducible manner.

105. The device of claim 89, wherein the anchoring member comprises an arched frame and at least three tooth-engaging components mounted on the arched frame, the tooth-engaging components being configured such that, when the anchoring member is properly affixed to a jaw of a subject, each of the tooth-engaging components is coupled to a respective at least one tooth.

106. A system for shaping a tooth, the system comprising the device according to claim 89, and a processing circuitry comprising a processor and a memory, the processing circuitry being configured to:
receive from the imager, and/or the CNC machine, data indicative of a structure of a tooth, and, optionally, additional data indicative of a distance between the tooth and the dental turbine and an orientation of the dental turbine relative to the tooth; and
provide tooth-shaping instructions to the CNC machine based on the received data and a selected tooth shape.

107. A method for shaping a tooth of a subject, the method comprising stages of:
providing a dental device and a processing circuitry functionally associated with the dental device, wherein the dental device comprises a computerized numerical control (CNC) machine configured to control operation of a dental turbine, installed on the CNC machine;
removably affixing the dental device to a jaw of a subject such that the dental device remains stationary with respect to a set of teeth of a subject;
obtaining coordinates of a plurality of locations along a margin line on a surface of a tooth from the set of teeth and coordinates of an apex of the tooth, wherein the margin line demarcates a part of the tooth which is to be shaped, and wherein the coordinates are specified in terms of a CNC machine coordinate system;
utilizing the processing circuitry to (i) specify, in terms of the CNC machine coordinate system, a part of the tooth, which is to remain after the shaping of the tooth, based on the obtained coordinates, and (ii) generate tooth-shaping instructions for the CNC machine, based on said specification of the part of the tooth;
utilizing the CNC machine to shape the tooth, based on the generated tooth-shaping instructions;
utilizing an imager to acquire data indicative of a structure of the tooth; and
analyzing the acquired data to obtain therefrom the coordinates of the plurality of locations along the margin line and of the apex, wherein the imager comprises one or more of a 3D scanner, a camera(s), and a tactile probe.

108. A method for shaping at least two teeth of a subject in preparation for installing thereon a dental bridge, the method comprising performing the method of claim 107 with respect to each of the at least two teeth, such that the dental device is affixed only once, a single orientation of the CNC machine relative to the anchoring member is utilized, and:
for each tooth of the at least two teeth, CNC machine coordinates of a respective plurality of locations along a margin line on a surface of the tooth, and of a respective apex of the tooth, are obtained; and
the processing circuitry is utilized to (i) specify, in terms of the CNC machine coordinate system, respective parts the at least two teeth, which are to remain after the shaping of each of the at least two teeth, based on the obtained CNC machine coordinates, and (ii) generate teeth-shaping instructions for the CNC machine, based on said specification of the parts of the at least two teeth.
